(19) United States
(12) Patent Application Publication
(10) Pub. No.: US 2023/0357052 A1
(43) Pub. Date: Nov. 9, 2023

(54) WATER PURIFICATION APPARATUS AND CONTROL METHOD THEREFOR

(71) Applicant: SAMSUNG ELECTRONICS CO., LTD., Suwon-si (KR)

(72) Inventors: Jungha PARK, Suwon-si (KR); Junggeun LEE, Suwon-si (KR); Jongho LEE, Suwon-si (KR)

(73) Assignee: SAMSUNG ELECTRONICS CO., LTD., Suwon-si (KR)

(21) Appl. No.: 18/222,884

(22) Filed: Jul. 17, 2023

Related U.S. Application Data
(63) Continuation of application No. PCT/KR22/00214, filed on Jan. 6, 2022.

(30) Foreign Application Priority Data
Mar. 3, 2021 (KR) 10-2021-0028390
Jun. 3, 2021 (KR) 10-2021-0072033

(51) Int. Cl. C02F 1/00; B67D 1/12; B67D 1/00; B67D 1/08

(52) U.S. Cl. CPC C02F 1/008; C02F 1/003; B67D 1/1243; B67D 1/0014; B67D 1/0888; C02F 2201/005; C02F 2307/06; B67D 2210/0001

(57) ABSTRACT

A water purification apparatus includes: a flow path; a dispenser provided at one end of the flow path; a user interface provided on the dispenser; a valve provided in the flow path; a valve drive operatively connected to the valve; a flow sensor provided in the flow path; a memory storing instructions; and a processor operatively connected to the user interface, the valve drive, the flow sensor, and the memory, wherein the processor is configured to execute the instructions to: control, based on an input obtained through the user interface, a start of discharging a liquid by controlling the valve drive to open the valve and discharge the liquid, identify, based on an output signal of the flow sensor, a discharged amount of the liquid after the start of discharging the liquid, and control, based on a resumption of discharging of the liquid after a stop of discharging the liquid, the user interface to display a total discharged amount of the liquid discharged before the stop of discharging of the liquid and after the start of discharging of the liquid.

### CROSS-REFERENCE TO RELATED APPLICATIONS

This application is by-pass continuation application of International Application No. PCT/KR2022/000214, filed on Jan. 6, 2022, which based on and claims priority to Korean Patent Application No. 10-2021-0028390, filed on Mar. 3, 2021, in the Korean Intellectual Property Office, and Korean Patent Application No. 10-2021-0072033, filed on Jun. 3, 2021, in the Korean Intellectual Property Office, the disclosures of which are incorporated by reference herein in their entireties.

### BACKGROUND

### 1. Field

The disclosure relates to a water purification apparatus and control method therefor, and more particularly, to a water purification apparatus capable of interacting with a user and method for controlling the water purification apparatus.

### 2. Description of Related Art

A water purification apparatus is a device for providing drinking water for a user by removing harmful materials contained in raw water such as tap water or ground water in various water purification methods such as precipitation, filtration and sterilization. The water purification apparatus is configured to supply clean water to the user by filtering the incoming water with one or more water purifying filters.

A water purification apparatus may be classified by shape into a direct connection type, that connects directly to the tap, and a storage type that contains water in a container to pass a filter. In addition, the water purification apparatus may be classified into natural filtration type, direct filtration type, ion exchange resin type, distillation type, reverse osmosis type, etc., according to the principle or method of water purification.

The water purified by the water purification apparatus may be released through a faucet and used for drinking or cooking.

With recent developments of information and communication technologies, the user may obtain quantized recipes for cooking foods. In this case, the quantized recipes recommend using an exact amount of water, so the demands of users for a water purification apparatus capable of providing the exact amount of water are growing.

### SUMMARY

Provided are a water purification apparatus and control method therefor, capable of indicating a discharged amount of liquid while discharging the liquid.

Also, provided are a water purification apparatus and control method therefor, which adds an amount of a liquid discharged after a pause of discharging the liquid to an amount of the liquid discharged before the pause, when the discharging of the liquid continues after the pause.

Additional aspects will be set forth in part in the description which follows and, in part, will be apparent from the description, or may be learned by practice of the presented embodiments.

According to an aspect of the disclosure, a water purification apparatus includes: a flow path; a dispenser provided at one end of the flow path; a user interface provided on the dispenser; a valve provided in the flow path; a valve drive operatively connected to the valve; a flow sensor provided in the flow path; a memory storing instructions; and a processor operatively connected to the user interface, the valve drive, the flow sensor, and the memory, wherein the processor is configured to execute the instructions to: control, based on an input obtained through the user interface, a start of discharging a liquid by controlling the valve drive to open the valve and discharge the liquid, identify, based on an output signal of the flow sensor, a discharged amount of the liquid after the start of discharging the liquid, and control, based on a resumption of discharging of the liquid after a stop of discharging the liquid, the user interface to display a total discharged amount of the liquid discharged before the stop of discharging of the liquid and after the start of discharging of the liquid.

The processor may be further configured to execute the instructions to, based on reception of a user input to stop discharging the liquid, control the valve drive to close the valve and store a total discharged amount of the liquid discharged before the stop of discharging of the liquid and after the start of discharging the liquid.

The processor may be further configured to execute the instructions to, based on reception of a user input to resume discharging the liquid within a reference time after the stop of discharging of the liquid, control the valve drive to open the valve and control the user interface to display the stored total discharged amount of the liquid.

The processor may be further configured to execute the instructions to, based on passage of the reference time after the stop of discharging of the liquid, initialize the stored discharged amount of the liquid.

The processor may be further configured to execute the instructions to, based on reception of a user input to resume discharging the liquid after the reference time elapses, control the valve drive to open the valve and control the user interface to display the initialized discharged amount of the liquid.

The processor may be further configured to execute the instructions to control the valve drive to close the valve based on determining an output signal of the flow sensor to indicate the discharged amount of the liquid to be equal to or larger than a target amount.

The processor may be further configured to execute the instructions to implement control the valve drive to close the valve based on reception of a user input to stop discharging the liquid through the user interface.

The processor may be further configured to execute the instructions to: stop discharging of the liquid, store the total discharged amount of the liquid discharged before the stop of discharging the liquid and after the start of discharging the liquid, and based on reception of a user input to resume discharging of the liquid, resume discharging of the liquid, and control the user interface to display the stored discharged amount of the liquid.

The processor may be further configured to execute the instructions to: end, based on reception of a user input to stop discharging the liquid, discharging of the liquid; and based on reception of a user input to resume discharging of the liquid, resume discharging of the liquid, and control the user interface to display an initial discharged amount of the liquid.

The user interface may include a button for receiving a user input to pause discharging of the liquid, and the water purification apparatus may include a lever configured to end discharging the liquid.

The user interface may include a touch button, and the processor may be further configured to execute the instructions to: obtain a user input to pause discharging of the liquid based on reception of a touch input, to the touch button, that is shorter than a reference time; and obtain a user input to end discharging the liquid based on reception of a touch input, to the touch button, that is longer than the reference time.

The processor may be further configured to execute the instructions to control the user interface to display a discharged amount which increases by a unit amount from an initial discharged amount each time the discharged amount of the liquid based on an output signal of the flow sensor reaches the unit amount.

The processor may be further configured to execute the instructions to control the user interface to display a discharged amount which decreases by a unit amount from a target amount each time the discharged amount of the liquid based on an output signal of the flow sensor reaches the unit amount.

According to an aspect of the disclosure, a method of controlling a water purification apparatus including a flow path, a dispenser provided at one end of the flow path and a valve provided in the flow path, includes: based on a user input obtained through a user interface provided on the dispenser, opening the valve to start discharging a liquid; displaying a discharged amount of the liquid each time the discharged amount of the liquid is determined, based on an output signal of a flow sensor arranged in the flow path, to reach a unit amount; and based on resumption of discharging of the liquid after a stop of discharging of the liquid, displaying a total discharged amount of the liquid discharged before the stop of discharging of the liquid and after the start of discharging of the liquid.

The displaying of the total discharged amount of the liquid discharged before the stop of discharging of the liquid and after the start of discharging of the liquid may include: based on reception of a user input to stop discharging the liquid, closing the valve and storing the total discharged amount of the liquid discharged before the stop of discharging of the liquid and after the start of discharging of the liquid, and based on reception of a user input to resume discharging of the liquid within a reference time after the stop of discharging of the liquid, opening the valve and displaying the stored total discharged amount of the liquid.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 schematically illustrates a water purification apparatus, according to an embodiment;

FIG. 2 illustrates a flow path in a filtering body of a water purification apparatus, according to an embodiment;

FIG. 3 illustrates a dispenser of a water purification apparatus, according to an embodiment;

FIG. 4 is a side cross-sectional view of a dispenser of a water purification apparatus, according to an embodiment;

FIG. 5 illustrates a configuration of a water purification apparatus, according to an embodiment;

FIG. 6 illustrates a user interface of a water purification apparatus, according to an embodiment;

FIG. 7 illustrates an operation of a water purification apparatus discharging a liquid, according to an embodiment;

FIG. 8 illustrates an example of displaying a discharged amount of a liquid, according to the operation shown in FIG. 7;

FIG. 9 illustrates an operation of a water purification apparatus discharging a liquid, according to an embodiment;

FIG. 10 illustrates an example of displaying a discharged amount of a liquid, according to the operation shown in FIG. 9;

FIG. 11 illustrates an operation of a water purification apparatus re-discharging a liquid, according to an embodiment;

FIG. 12 illustrates an example of displaying a discharged amount of a liquid, after initialization of a previously discharged amount, according to the operation shown in FIG. 11;

FIG. 13 illustrates an example of displaying a discharged amount of a liquid, by adding a previously discharged amount, according to the operation shown in FIG. 11;

FIG. 14 illustrates an operation of a water purification apparatus re-discharging a liquid, according to an embodiment;

FIG. 15 illustrates an example of displaying a discharged amount of a liquid, after initialization of a previously discharged amount, according to the operation shown in FIG. 14;

FIG. 16 illustrates an example of displaying a discharged amount of a liquid, by adding a previously discharged amount, according to the operation shown in FIG. 14;

FIG. 17 illustrates an operation of a water purification apparatus re-discharging a liquid, according to an embodiment;

FIG. 18 illustrates an example of displaying a discharged amount of a liquid, by adding a previously discharged amount, according to the operation shown in FIG. 17;

FIG. 19 illustrates an operation of a water purification apparatus re-discharging a liquid, according to an embodiment;

FIG. 20 illustrates an example of displaying a discharged amount of a liquid, by adding a previously discharged amount, according to the operation shown in FIG. 19; and

FIG. 21 illustrates an operation of a water purification apparatus pausing discharging of a liquid, according to an embodiment.

### DETAILED DESCRIPTION

Like numerals refer to like elements throughout the specification. Not all elements of embodiments of the disclosure will be described, and description of what are commonly known in the art or what overlap each other in the embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

Throughout the specification, when it is said that a member is located “on” another member, it implies not only that the member is located adjacent to the other member but also that a third member exists between the two members.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

The principle and embodiments of the disclosure will now be described with reference to accompanying drawings.

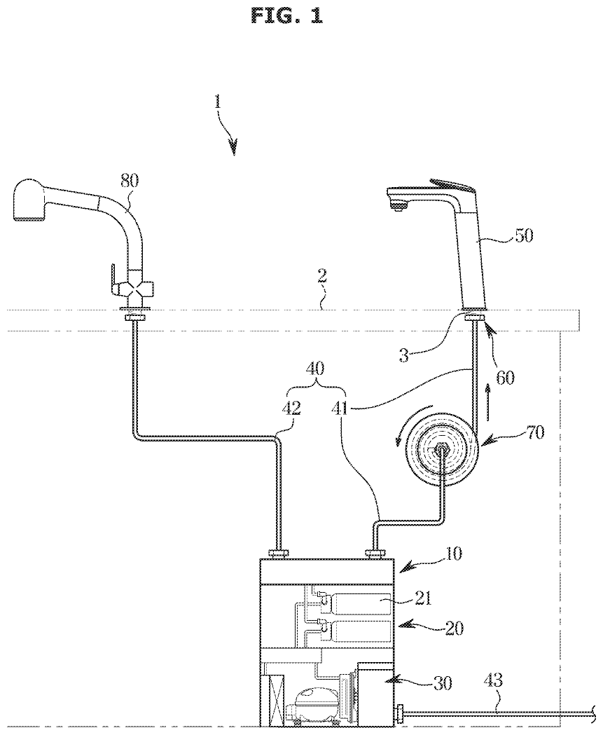

FIG. 1 schematically illustrates a water purification apparatus, according to an embodiment.

Referring to FIG. 1, a water purification apparatus 1 may include a filtering body 10 and a dispenser 50 connected to the filtering body 10 for discharging a liquid out of the filtering body 10. The filtering body 10 may be arranged in a lower portion of a kitchen workbench 2, and the dispenser 50 may be arranged on the kitchen workbench 2. The kitchen workbench 2 may include a sink part. The sink part may include a sink and a kitchen countertop.

The dispenser 50 may be rotationally arranged on the kitchen workbench 2. For example, the dispenser 50 may be rotationally installed over the sink part. The dispenser 50 may be connected to the filtering body 10 through a connection pipe 40

The filtering body 10 may be arranged inside the kitchen workbench 2. The filtering body 10 may include a filter unit 20 including at least one filter 21 and a heat exchange unit 30 arranged to cool or heat the liquid purified by the filter unit 20. The heat exchange unit 30 may include a cooler and a heater.

The filtering body 10 may receive raw water such as tap water through an external pipe 43.

The connection pipe 40 of the filtering body 10 may include a first pipe 41 connecting the filtering body 10 to the dispenser 50, and a second pipe 42 connecting the filtering body 10 to a faucet 80 installed on the kitchen workbench 2.

An installation member 3 may be provided for installing the dispenser 50 on the kitchen workbench 2. The installation member 3 may be formed by opening at least a portion of the kitchen workbench 2. The dispenser 50 may be connected to the first pipe 41 through the installation member 30 of the kitchen workbench 2.

The dispenser 50 may be rotationally installed at the installation member 3. The water purification apparatus 1 may include a rotation member 60 for rotationally installing the dispenser 50 at the installation member 3. The rotation member 60 may be coupled to the kitchen workbench 2.

The water purification apparatus 1 may include a pipe fixing member 70 arranged to secure the first pipe 41 and the second pipe 42. The pipe fixing member 70 may be arranged inside the kitchen workbench 2. The pipe fixing member 70 may be arranged between the filtering body 10 and the dispenser 50. The pipe fixing member 70 may be fixed to at least one of the filtering body 10 and the kitchen workbench 2. The pipe fixing member 70 may be wound with portions of the first pipe 41 and the second pipe 42, and as the portions of the first pipe 41 and the second pipe 42 wind or unwind from the pipe fixing member 70, the length of the first pipe 41 and the second pipe 42 may extend or be shortened.

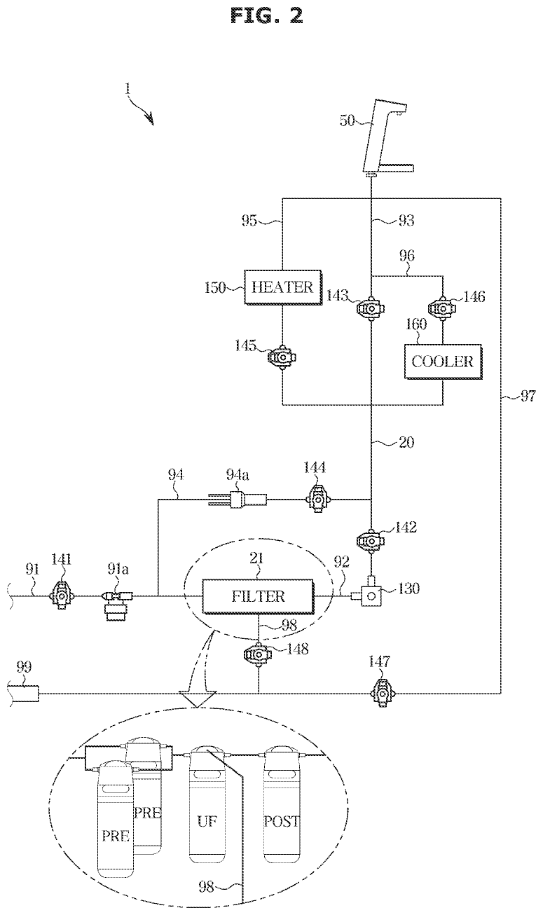

FIG. 2 illustrates a flow path in a filtering body of a water purification apparatus, according to an embodiment.

Referring to FIG. 2, a source path 91 into which raw water such as tap water flows from outside, filtered path 92 and filtered path 93 extending from the source path 91 to the dispenser 50, or drain path 97 and drain path 98 branched from the filtered path 92 may be arranged in the filtering body 10. The filter 21 arranged in the filtered path 92 and the filtered path 93 to filter the raw water and a drain 99 for draining the liquid from inside the water purification apparatus 1 to the outside may be further provided. The paths arranged in the water purification apparatus 1 may be formed by a plurality of pipes.

The source path 91 may be connected to the external pipe 43 to receive the raw water. A raw water valve 141 for controlling inflow of the raw water and a regulator 91a for reducing the pressure of the raw water may be arranged in the source path 91.

A sediment filter for filtering out sediments contained in the raw water or a high-turbidity filter for filtering out relatively coarse-grained particles may be further arranged in the source path 91.

The filtered path 92 and the filtered path 93 may include the first filtered path 92 and the second filtered path 93. The first filtered path 92 may be connected to the source path 91 for receiving the raw water from the source path 91, and may be connected to the second filtered path 93. The second filtered path 93 may extend to the dispenser 50.

The filter 21 for filtering the raw water may be arranged in the first filtered path 92. The filter 21 may include, for example, a pre-carbon filter that adsorbs volatile materials such as chlorine and chlorine byproducts from the raw water, a membrane filter that filters off very fine contaminants by reverse osmosis, and a post-carbon filter that affects the taste of the purified water discharged. In this case, the filter 21 may be connected in the sequence of the pre-carbon filter, the membrane filter, and the post-carbon filter, and the raw water brought into the filter 21 may be filtered by sequentially passing the pre-carbon filter, the membrane filter, and the post-carbon filter.

These types of filters 21 are merely an example to be applied to embodiments of the water purification apparatus 1, and the embodiments of the water purification apparatus 1 are not limited thereto. It is also possible that different types and different numbers of filters may be provided in different layouts.

A first purified water valve 142 for controlling a flow of the purified water filtered by the filter 21 may be arranged downstream of the filter 21.

In embodiments of the water purification apparatus 1, upstream, downstream, and front and rear ends of the air purifier 1 are determined based on a direction in which the liquid brought into the air purification apparatus 1 flows. A side relatively nearer to where the raw water is brought in from the outside is upstream or the front end, and a side relatively nearer to where the water is discharged is downstream or the rear end.

The water purification apparatus 1 may include, for example, a sterilized water path 94 for the raw water to detour around the filter 21, be processed and produced into sterilized water. An end of the sterilized water path 94 may be connected to the downstream of the regulator 91a and the other end of the sterilized water path 94 may be connected to the downstream of the first purified water valve 142. For example, the first filtered path 92 may be integrally connected with the source path 91, and the sterilized water path 94 may be formed as a bypass from the source path 91. Accordingly, the raw water may pass through at least one of the first filtered path 92 and the sterilized water path 94.

In the sterilized water path 94, a sterilized water generator 94a for producing sterilized water and a sterilized water valve 144 for controlling inflow of the raw water from the source path 91 may be arranged.

For example, the sterilized water generator 94a may be implemented with an electrolyzer that electrolyzes the liquid to produce sterilizing substances. The sterilized water generator 94a is not, however, limited to the above example, and any known type of devices that are able to produce the sterilized water may be employed. For example, the sterilized water generator 94a may be implemented with an ultraviolet lamp or a light emitting diode (LED) lamp.

A flow sensor may be arranged in the first filtered path 92 for detecting a flow rate in the first filtered path 92. For example, the flow sensor 130 may be arranged downstream of the filter 21. The flow sensor 130 may detect a flux of the liquid that passes the flow sensor 130 when e.g., the liquid flows to pass the flow sensor 130 such as when the first purified water valve 142 and the second purified water valve 143 are opened for the purified water to be discharged through the dispenser 50. The flow sensor 130 may output an electric signal (e.g., a current signal or a voltage signal) corresponding to the flux of the liquid passing the flow sensor 130.

The water purification apparatus 1 may further include a cold/hot water device for providing cold water or hot water, and the cold/hot water device may include a heat exchanger. The cold/hot water device may be arranged downstream of the first filtered path 92.

The water purification apparatus 1 may include a hot water path 95 branched from the second filtered path 93 in a downstream area of the first filtered valve 142. In the hot water path 95, a heater 150 for heating the purified water and a hot water valve 145 for opening or closing the hot water path 95 may be arranged. In this case, an end of the hot water path 95 may be connected to upstream of the second purified water valve 143, and the other end of the hot water path 95 may be connected to downstream of the second purified water valve 143.

The water purification apparatus 1 may include a cold water path 96 branched from the second filtered path 93 in a downstream area of the first filtered valve 142. In the cold water path 96, a cooler 160 for cooling the purified water and a cold water valve 146 for opening or closing the cold water path 96 may be arranged. In this case, an end of the cold water path 96 may be connected to upstream of the second purified water valve 143, and the other end of the cold water path 96 may be connected to downstream of the second purified water valve 143.

A first drain path 97 may be branched from the second purified water path 93 in a downstream area of the second purified water valve 143. Specifically, the first drain path 97 is branched from the second filtered path 93 in a downstream area of the second purified water valve 143 and connected to the drain 99, allowing the liquid of the filtered paths 92 and 93 to be drained to the outside.

In the first drain path 97, a first drain valve 147 for controlling the flux of the purified water by opening or closing the first drain path 97 and a check valve for preventing the purified water from flowing backward may be arranged. When the first drain valve 147 is opened, the purified water having flown in the first filtered path 92 and the second filtered path 93 flows into the first drain path 97 and may be discharged to the outside through the drain 99 of the water purification apparatus 1 connected to an end of the first drain path 97.

A terminal end of the second filtered path 99 may be connected to the dispenser 50. The second purified water valve 143 for controlling the flux of the purified water may be arranged downstream of the first purified water valve 142 and upstream of the dispenser 50. Specifically, when the first purified water valve 142 and the second purified water valve 143 are opened, the purified water filtered by the filter 21 may be discharged to the outside through the dispenser 50 arranged at the end of the first filtered path 92 and the second filtered path 93.

The water purification apparatus 1 may include a second drain path 98 branched from the filter 21 and connected to the drain 99. For example, the second drain path 98 may lead the raw water that cleans the filter 21 to the drain 99.

In this case, in the second drain path 98, a second drain valve 148 may be arranged to control the flux of the row water to clean the filter 21 by opening or closing the second drain path 98.

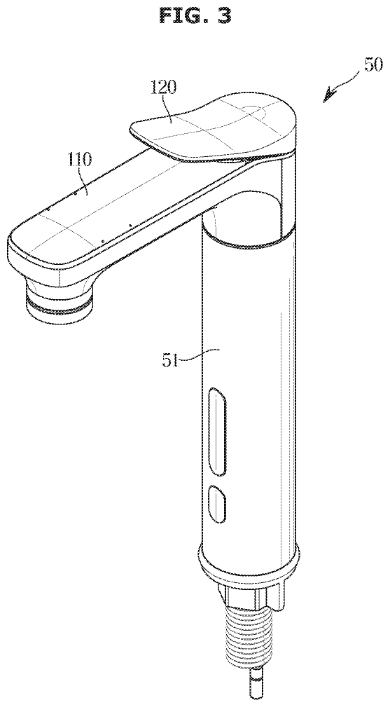

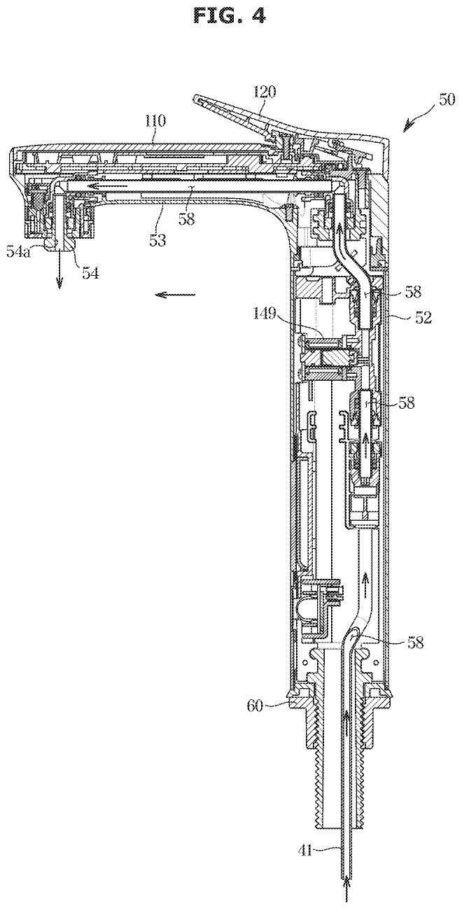

FIG. 3 illustrates a dispenser of a water purification apparatus, according to an embodiment. FIG. 4 is a side cross-sectional view of a dispenser of a water purification apparatus, according to an embodiment.

The dispenser 50 may include a dispenser body 51 that forms the exterior and has various components arranged therein. The dispenser body 51 may be formed in the shape of almost “F”. The dispenser body 51 may be rotationally coupled to the kitchen workbench 2 at one end.

The dispenser body 51 may include a neck 52 extending almost upward and a head 53 extending almost horizontally from the top end of the neck 52, and the bottom end of the neck 52 may be rotationally coupled by the rotation member 60 to the kitchen workbench 2.

The neck 52 and the head 53 may be separately formed and then coupled together, or may be integrally formed.

The neck 52 may be perpendicular or inclined to a surface of the kitchen workbench 2 on which the installation member 3 is formed.

The dispenser 50 may include a dispensing nozzle 54 arranged at the other end of the dispenser body 51 with one end coupled with the kitchen workbench 2. The dispensing nozzle 54 may be arranged at the other end of the head 53 opposite from one end of the head 53 coupled to the neck 52. The dispensing nozzle 54 may extend vertically, and an outlet 54a may be arranged at the bottom of the other end of the dispenser body 51. The dispensing nozzle 54 may be fixed to the head 53, and may be changed in position according to rotation of the dispenser body 51.

A dispensing path 58 in which the liquid supplied by the filtering body 10 may flow may be arranged in the dispenser body 51. The dispensing path 58 may extend to the outlet 54a of the dispensing nozzle 54.

The dispenser 50 may include a dispensing valve 149 for allowing or blocking the flow of the liquid. In other words, the dispensing valve 149 may control whether to discharge the liquid through the outlet 54a. The dispensing valve 149 may be arranged in the dispensing path 58. The dispensing valve 149 may open or close the dispensing path 58.

The dispensing valve 149 may be arranged inside the dispenser body 51. The dispensing valve 149 may be arranged in the neck 52.

The dispenser 50 may include a dispensing lever 120 for controlling the dispensing valve 149. The dispensing lever 120 may control the discharging of the liquid through the outlet 54a by controlling the dispensing valve 149.

The dispenser 50 may include a user interface 110 for receiving a touch input and outputting an image. The user interface 110 may be arranged on the upper surface of the dispenser 50. Specifically, the head 53 may be opened upward, and the user interface 110 may be coupled to the top side of the open head 53 to cover the internal space of the head 53 having various electronic components arranged therein.

The type and position of the user interface 110 is not, however, limited thereto, and any type and position that allows an input of a type and/or hot water set temperature of the liquid to be discharged to be received from the user may be used without being limited thereto. In the following description, the user interface 110 corresponds to a display that is able to display various information and receive a touch input.

The user interface 110 may be arranged above the dispensing nozzle 54. The user interface 110 may be arranged on a side of the other end of the head 53 opposite from the one end of the head 53 connected to the neck 52. The user interface 110 may extend from the other end of the head 53 by a certain length toward the one end of the head 53.

The user interface 110 is described below in more detail.

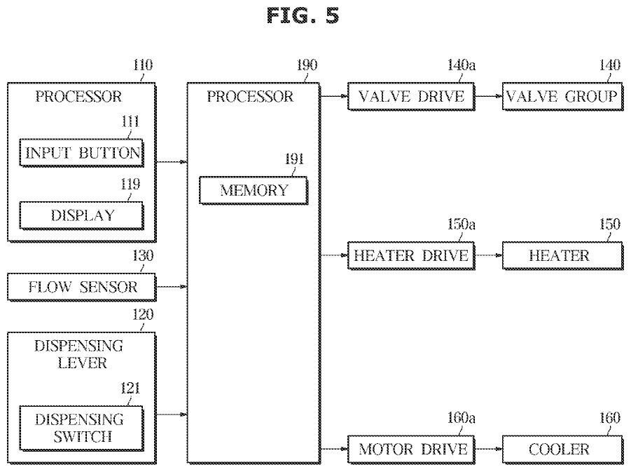

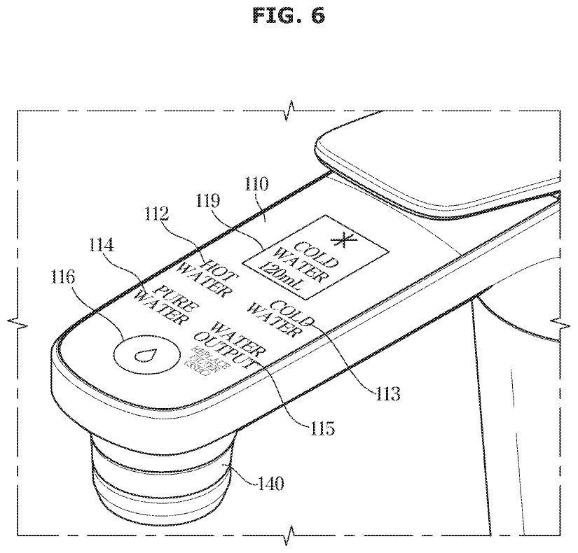

FIG. 5 illustrates a configuration of a water purification apparatus, according to an embodiment. FIG. 6 illustrates a user interface of a water purification apparatus, according to an embodiment.

Referring to FIG. 5 and FIG. 6, the water purification apparatus 1 may include the user interface 110, the dispensing lever 120, the flow sensor 130, a valve group 140 (the raw water valve 141, the first purified water valve 142, the second purified water valve 143, the sterilized water valve 144, the hot water valve 145, the cold water valve 146, the first drain valve 147, the second drain valve 148, and the dispensing valve 149), a valve drive 140a, the heater 150, a heater drive 15a, the cooler 160, a motor drive 160a and a processor 190.

The user interface 110 may be arranged on the upper surface of the dispenser 50.

The user interface 110 may include, for example, an input button 111 for obtaining a user input, and a display 119 for displaying a discharge setting and/or operation information of the water purification apparatus 1 in response to the user input.

The input button 111 may include a plurality of buttons for obtaining various user inputs.

For example, as shown in FIG. 6, the input button 111 may further include a hot water button 112 for obtaining a user input to set discharging of hot water through the dispenser 50, a cold water button 113 for obtaining a user input to set discharging of cold water through the dispenser 50, a purified water button 114 for obtaining a user input to set discharging of purified water through the dispenser 50, a setting button 115 for obtaining a user input to set a target amount of the liquid to be discharged through the dispenser 50, or a dispensing button 116 for obtaining a user input to request discharging of the liquid (e.g., hot water, cold water or purified water) through the dispenser 50.

The input button 111 may include, for example, a tact switch, a push switch, a slide switch, a toggle switch, a micro switch, or a touch switch.

The input button 111 may include a plurality of light sources that emit light depending on whether the water purification apparatus 1 is activated. For example, the input button 111 may include a first light source arranged underneath the hot water button 112, a second light source arranged underneath the cold water button 113, a third light source arranged underneath the purified water button 114, a fourth light source arranged underneath the setting button 115 and/or a fifth light source arranged underneath the dispensing button 116. The first light source, second light source, third light source, fourth light source and/or fifth light source may be turned off during a standby mode of the water purification apparatus 1 and turned on while the water purification apparatus 1 is activated. The first light source, second light source, third light source, fourth light source and/or fifth light source may include, for example, an LED.

Each of the plurality of buttons may obtain a user input and provide an electric signal (e.g., a voltage signal or a current signal) that represents the user input to the processor 190. The processor 190 may identify the user input based on an output signal of the plurality of buttons. For example, the processor 190 may control the valve group 140 to discharge hot water, cold water or purified water based on the user input from the hot water button 112, the cold water button 113 or the purified water button 114. The processor 190 may also set a target amount of the liquid to be discharged through the dispenser 50 based on the user input from the setting button 115. The target amount may be preset to 120 ml, 250 ml, 1,000 ml, etc., and the setting button 115 may set the target amount of the liquid based on the number of times of touching or pushing the setting buttons 115.

The display 119 may receive a display signal from the processor 190. The display 119 may display setting information corresponding to a user input and/or operation information of the water purification apparatus 1 according to the display signal.

For example, as shown in FIG. 6, the display 119 may display a temperature of the liquid set by the input button 111 (e.g., temperature, cold water or purified water) and/or a discharge amount of the liquid set by the setting button 115, during no discharge of the liquid. Furthermore, the display 119 may display a discharged amount of the liquid being discharged through the dispenser 50 while the liquid is being discharged.

The display 119 may include, for example, a liquid crystal display (LCD) panel, an LED panel, or the like.

The dispensing lever 120 may be arranged in the vicinity of the user interface 110 on the upper surface of the dispenser 50.

The dispensing lever 120 may be changed in position or posture due to e.g., physical pressure from the user. The dispensing lever 120 may include a dispensing switch 121 that is turned on or off (closed or opened) according to the position or posture of the dispensing lever 120. For example, when the dispensing lever 120 is in a first position or first posture, the dispensing switch 121 may be turned off (or opened). When the dispensing lever 120 is shifted by physical pressure from the user to a second position or second posture, the dispensing switch 121 may be turned on (or closed).

The dispensing switch 121 may obtain a user input to request discharging of the liquid (e.g., hot water, cold water or purified water) through the dispenser 50. The dispensing switch 121 may include, for example, a push switch, a micro switch or a lead switch.

The dispensing switch 121 may provide an electric signal that represents the user input obtained to the processor 190. The processor 190 may identify the user input to request discharging of the liquid based on the output signal of the dispensing switch 121.

The flow sensor 130 may be arranged in the filtered path 92 as described above for identifying a flux of the liquid passing the flow sensor 130. In other words, a flux of the liquid purified by the filter unit 20 and passing the filtered path 92 may be identified. Furthermore, the flow sensor 130 may identify a flow rate of the liquid passing the flow sensor 130, e.g., an amount of the liquid passing the flow sensor 130 in a unit time.

The flow sensor 130 may include, for example, a propeller arranged in the filtered path 92. The propeller may be rotated around a rotation axis which is substantially parallel to a direction in which the liquid flows. Rotation speed of the propeller may correspond to the flow rate of the liquid in the filtered path 92.

The flow sensor 130 may further include an encoder (e.g., a hall sensor) for detecting rotation and/or rotation speed of the propeller. An output signal of the encoder may represent the flux of the liquid or the flow rate of the liquid.

The flow sensor 130 may provide an electric signal that represents the flux of the liquid or the flow rate of the liquid to the processor 190. The processor 190 may identify an amount of the liquid having passed the flow sensor 130 or a discharged amount of hot water, cold water or purified water that has been discharged through the dispenser 50, based on the output signal of the flow sensor 130.

The valve group 140 may include the plurality of valves as described above in connection with FIG. 2 and FIG. 3. For example, the valve group 140 may include the raw water valve 141, the first purified water valve 142, the second purified water valve 143, the sterilized water valve 144, the hot water valve 145, the cold water valve 146, the first drain valve 147, the second drain valve 148 or the dispensing valve 149. The plurality of valves may each be arranged in the source path 91, the filtered path 92, the sterilized water path 94, the hot water path 95, the cold water path 96, the first drain path 97, or the second drain path 98.

The plurality of valves may be electric operated valves (e.g., solenoid valves) that open or close the flow path according to a driving current (or driving voltage).

The valve drive 140a may apply a driving current (or driving voltage) to each of the plurality of valves included in the valve group 140 in response to an open or close signal of the processor 190. For example, the valve drive 140a may apply a driving current to the plurality of valves to open the plurality of valves or block the driving current to the plurality of valves to close the plurality of valves.

The valve drive 140a may include, for example, a power switch (e.g., a metal-oxide semiconductor field-effect-transistor (MOSFET), a bipolar junction transistor (BJT), an insulated gate bipolar mode transistor (IGBT), etc.) capable of applying or blocking a driving current to each of the plurality of valves in response to the open or close signal of the processor 190, and associated circuits.

The heater 150 may be arranged in the hot water path 95 to heat the liquid (e.g., purified water) passing the hot water path 95.

The heater 150 may emit heat based on the driving current (or driving voltage). An amount of the heat emitted by the heater 150 may be proportional to the square of the driving current applied to the heater 150.

The heater drive 150a may apply a driving current (or driving voltage) to the heater 150 in response to a heating signal of the processor 190. For example, the heater drive 150a may apply a driving current to the heater 150 so that the heater 150 heats the liquid, or block the driving current to the heater 150 not to heat the liquid.

The heater drive 150a may include, for example, a power switch capable of applying or blocking a driving current to the heater 150 in response to a heating signal of the processor 190, and associated circuits.

The cooler 160 may be arranged in the cold water path 96 to cool the liquid (e.g., purified water) passing the cold water path 96.

The cooler 160 may include a cooling circuit including, for example, a compressor, a condenser, an expander, and an evaporator. The compressor may include a motor, and use motor torque to circulate a refrigerant in the cooling circuit. The cooler 160 may cool the liquid by evaporation of the refrigerant circulating in the cooling circuit.

The motor drive 160a may apply a driving current (or driving voltage) to the motor included in the cooler 160 in response to a cooling signal of the processor 190. For example, the motor drive 160a may apply a driving current to the motor so that the cooler 160 cools the liquid, or block the driving current to the cooler 160 not to cool the liquid.

The motor drive 160a may include, for example, a power switch capable of applying or blocking a driving current to the motor of the cooler 160 in response to a cooling signal of the processor 190, and associated circuits. The motor drive 160a may include an inverter circuit for applying or blocking the driving current to the motor.

The processor 190 may be electrically connected to the user interface 110, the dispensing lever 120, the flow sensor 130, the valve drive 140a, the heater drive 150a or the motor drive 160a. The processor 190 may process an output signal of the user interface 110, the dispensing lever 120 or the flow sensor 130. In response to this, the processor 190 may provide a control signal to the valve drive 140a, the heater drive 150a or the motor drive 160a.

The processor 190 may include a memory 191 for storing a program (or a plurality of instructions) or data for processing signals and providing control signals. The memory 191 may include a volatile memory, such as a static random access memory (S-RAM), a dynamic RAM (D-RAM), or the like, and a non-volatile memory, such as a read only memory (ROM), an erasable programmable ROM (EPROM) or the like. The memory 191 may be integrated with the processor 190 or provided as a semiconductor device separated from the processor 190.

There may also be an external memory arranged outside the processor 190.

The processor 190 may process a signal based on the program or data stored in the memory 191, and may further include a processing core (e.g., an operation circuit, a storage circuit, and a control circuit) that outputs a control signal.

The processor 190 may process an output signal of the user interface 110 or the dispensing lever 120, and identify a user input.

In response to the user input, the processor 190 may provide a control signal to the valve drive 140a, the heater drive 150a or the motor drive 160a to discharge hot water, cold water or purified water.

For example, the processor 190 may identify a user input to select hot water based on an output signal of the user interface 110. In response to the user input to select hot water, the processor 190 may control the heater drive 150a to activate the heater 150 and control the valve drive 140a to open the hot water valve 145 and the first purified water valve 142.

The processor 190 may identify a user input to select cold water based on an output signal of the user interface 110. In response to the user input to select the cold water, the processor 190 may control the motor drive 160a to activate the cooler 160 and control the valve drive 140a to open the cold water valve 146 and the first purified water valve 142.

The processor 190 may identify a user input to request discharging of the liquid (hot water, cold water or purified water) based on an output signal of the user interface 110 or the dispensing switch 121. In response to the user input to request discharging of the liquid, the processor 190 may control the valve drive 140a to open the dispensing valve 149.

The processor 190 may identify an amount of the liquid that has been discharged through the dispenser 50, based on an output signal of the flow sensor 130. The processor 190 may obtain information about a flow rate (or a flow amount) passing the flow sensor 130 from the flow sensor 130 (e.g., an output signal of the hall sensor), and identify an amount of the liquid passing the flow sensor 130 (i.e., a discharged amount of the liquid) by accumulating the flow rate (or the flow amount) of the liquid.

The processor 190 may provide a control signal to the display 119 to display a discharged amount of the liquid, based on the identifying of the discharged amount of the liquid. For example, the processor 190 may update the discharged amount of the liquid each time the discharged amount of the liquid reaches a preset unit amount (e.g., 1 ml, 10 ml, etc.), and provide a control signal to the display 119 to display the updated discharged amount of the liquid. Accordingly, the display 119 may display the amount of the liquid discharged at intervals of the preset unit amount. For example, the display 119 may display the discharged amount at intervals of 10 ml, i.e., at 10 ml, 20 ml, 30 m, etc., depending on the dispenser 50 discharging the liquid.

The processor 190 may identify a user input to stop discharging the liquid (hot water, cold water or purified water) based on an output signal of the user interface 110 or the dispensing switch 121. In response to the user input to stop discharging, the processor 190 may control the valve drive 140a to stop discharging the liquid. For example, the processor 190 may control the valve drive 140a to close the hot water valve 145, the cold water valve 146, the first purified water valve 142, the second purified water valve 143, and the dispensing valve 149.

Furthermore, the processor 190 may control the valve drive 140a to stop discharging the liquid based on the discharged amount of the liquid reaching a target amount set by the user. The processor 190 may obtain the target amount of the liquid to be discharged based on an output signal of the user interface 110 (e.g., the setting button). The processor 190 may identify an amount of the liquid discharged through the dispenser 50, and control the valve drive 140a to stop discharging the liquid based on the discharged amount of the liquid equal to or larger than the target amount.

After discharging of the liquid is stopped, the processor 190 may identify a user input to request discharging the liquid again. In response to this, the processor 190 may control the valve drive 140a to open the dispensing valve 149.

In response to the identifying of the user input to request discharging the liquid again, the processor 190 may control the display 119 to display the previous amount of the liquid that had been discharged until the discharging of the liquid was stopped. Furthermore, the processor 190 may identify an amount of the liquid discharged through the dispenser 50 based on an output signal of the flow sensor 130, and control the display 119 to display a total discharged amount of the liquid by adding the currently discharged amount of the liquid to the previous discharged amount of the liquid. In other words, the processor 190 may provide the user with an amount of the liquid discharged intermittently within a preset period of time.

This may allow the user to check or identify the total amount of the liquid discharged by the water purification apparatus 1 while the water purification apparatus 1 repeats discharging the liquid and stopping the discharging within the preset period of time.

Components of the water purification apparatus 1 have thus far been described. The components of the water purification apparatus 1 shown in FIG. 5 are, however, merely an example. For example, some of the components shown in FIG. 5 may be omitted or other components may be added.

For example, the water purification apparatus 1 may further include a communication device for communicating with an external device. The communication device may include, for example, a wireless communication module for wirelessly communicating with an external device or a wired communication module for wiredly communicating with the external device.

The wireless communication module may wirelessly exchange communication signals with an access point (AP) or a station. The AP or the station may be connected to a wide communication network (e.g., an intranet or the Internet). The wireless communication module may exchange communication signals with a server device in the wide communication network through the AP or the station.

The wired communication module may be connected to the wide communication network (e.g., an intranet or the Internet) through a hub, a router, a switch or a gateway. The wired communication module may also exchange communication signals with a server device in the wide communication network.

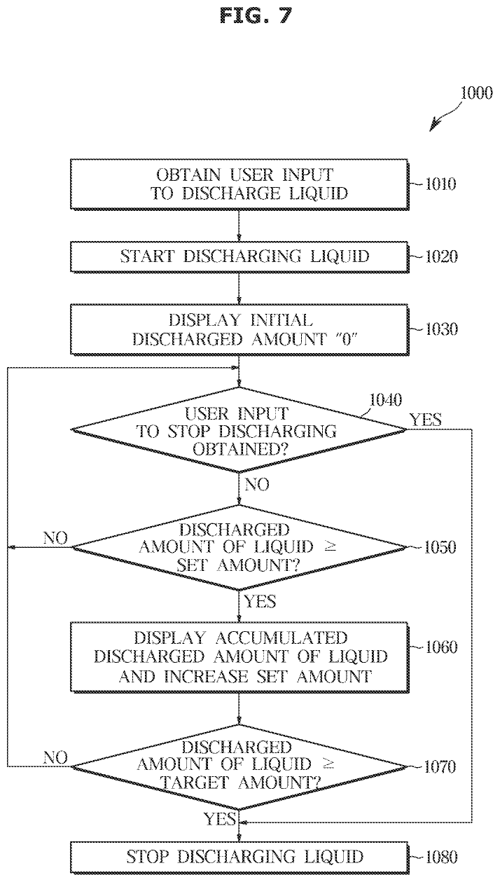

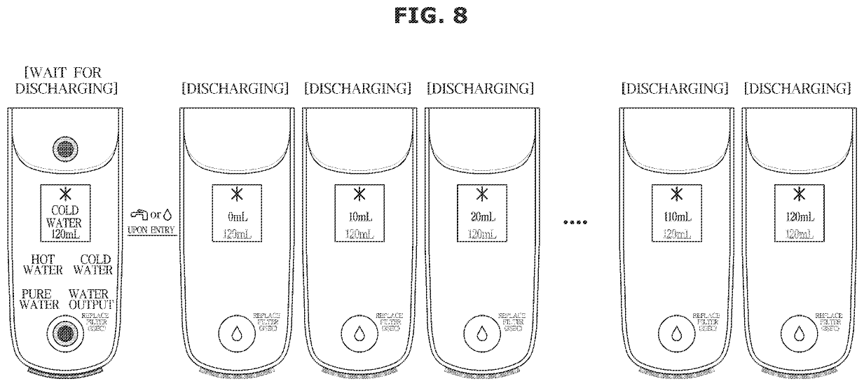

FIG. 7 illustrates an operation of a water purification apparatus discharging a liquid, according to an embodiment. FIG. 8 illustrates an example of displaying a discharged amount of a liquid, according to the operation shown in FIG. 7.

Operations 1000 of the water purification apparatus 1 discharging a liquid will be described in connection with FIG. 7 and FIG. 8.

The water purification apparatus 1 may obtain a user input to discharge a liquid as much as a target discharge amount, in operation 1010.

The processor 190 may obtain a user input to select a temperature of the liquid to be discharged (e.g., hot water, cold water or purified water at room temperature) from the hot water button 112, the cold water button 113, or the purified water button 114.

The processor 190 may obtain a user input to select an amount of the liquid to be discharged (e.g., 120 ml, 250 ml, 500 ml, or 1000 ml) from the setting button 115. For example, the processor 190 may obtain an amount of the liquid to be discharged based on the number of times of touching or pressing the setting button 115.

Furthermore, the processor 190 may obtain a user input to discharge the liquid without limitation on the amount of discharging (e.g., continuous discharging) from the setting button 115. In other words, the processor 190 may obtain a user input to discharge the liquid until another user input to stop discharging the liquid is input. For example, the processor 190 may obtain the user input to discharge the liquid without limitation on the amount of discharging based on the number of times of touching or pressing the setting button 115.

As such, the processor 190 may obtain an output signal of the hot water button 112, the cold water button 113, the purified water button 114 or the setting button 115, and set the temperature and/or amount of the liquid to be discharged through the dispenser 50 based on the output signal.

The processor 190 may obtain a user input to request discharging of the liquid from the dispensing button 116 of the user interface 110 or the dispensing switch 121 of the dispensing lever 120. The user may request (or instruct) discharging the liquid by touching the dispensing button 116 or request discharging the liquid by pressing the dispensing lever 120.

The processor 190 may not only obtain the user input through the user interface 110 or the dispensing lever 120 but also obtain the user input through the communication device from a user terminal.

For example, the water purification apparatus 1 may communicate with the user terminal through a server device connected to a wide communication network. The user terminal may display a graphic user interface having a similar shape to the user interface 110. The graphic user interface may include, for example, a hot water button, a cold water button, a purified water button, a setting button or a dispensing button. The user terminal may obtain a user input through the graphic user interface, and transmit the user input to the water purification apparatus 1 through the server device.

The water purification apparatus 1 may obtain a user input to set a temperature and/or amount of the liquid and a user input to request discharging the liquid from the user terminal through the server device.

The water purification device 1 may start discharging the liquid, in operation 1020.

In response to the user input obtained in operation 1010, the processor 190 may control the valve drive 140a to discharge the liquid through the dispenser 50. For example, the processor 190 may control the valve drive 140a to open the first purified water valve 142, control the valve drive 140a to open at least one of the hot water valve 145, the cold water valve 146 and the second purified water valve 143, and control the valve drive 140a to open the dispensing valve 149. The dispenser 50 may then discharge hot water, cold water or purified water.

The water purification apparatus 1 may display an initial discharged amount of “0”, in 1030.

The processor 190 may control the display 119 to display an amount of the liquid discharged through the dispenser 50 while the liquid is being discharged. For example, the processor 190 may display a discharge amount of “0 ml” when discharging of the liquid is started.

Furthermore, the processor 190 may display a target amount of the liquid to be discharged along with a discharged amount of the liquid. For example, when the target amount is 120 ml according to a user input, the processor 190 may control the display 119 to display the initial discharged amount “0 ml” along with the target discharge amount “120 ml”.

The water purification apparatus 1 may identify whether a user input to stop discharging the liquid is obtained while the liquid is being discharged.

The processor 190 may identify whether the user input to stop discharging the liquid is obtained through the user interface 110 or the dispensing lever 120 while the water purification apparatus 1 is discharging the liquid through the dispenser 50.

The processor 190 may identify the user input to stop discharging the liquid when the dispensing button 116 of the user interface 110 is touched or the dispensing lever 120 is pressed while the liquid is being discharged.

When the user input to stop discharging the liquid is identified in operation 1040, the water purification apparatus 1 may stop discharging the liquid, in operation 1080.

In response to the user input to stop discharging the liquid obtained, the processor 190 may control the valve drive 140a to stop discharging the liquid. For example, the processor 190 may control the valve drive 140a to close the hot water valve 145, the cold water valve 146, the first purified water valve 142, the second purified water valve 143, and the dispensing valve 149.

When the user input to stop discharging the liquid is not identified in operation 1040, the water purification apparatus 1 may identify whether a discharged amount of the liquid is equal to or larger than a set amount in operation 1050.

The flow sensor 130 may provide an output signal corresponding to a flux of the liquid or a flow rate of the liquid passing the flow sensor 130 to the processor 190.

The processor 190 may identify an amount of the liquid that has been discharged through the dispenser 50, based on an output signal of the flow sensor 130. For example, the processor 190 may identify an amount of the liquid passing the flow sensor 130 (i.e., a discharged amount of the liquid) by accumulating the flow rate (or flow amount).

The processor 190 may compare the discharged amount of the liquid with a set amount set for display, and identify whether the discharged amount of the liquid is equal to or larger than the set amount.

The set amount may be a unit amount for displaying a discharged amount of the liquid. For example, the set amount may be 1 ml or 10 ml. The set amount may vary by the discharged amount of the liquid. For example, when the first set amount is 10 ml and the discharged amount of the liquid is 10 ml or more, the set amount may be changed to 20 ml. In other words, the set amount may be changed to a positive integer multiple of the first set amount (e.g., X2, X3, X3 . . . ) depending on the discharged amount of the liquid.

When the discharged amount of the liquid is less than the set amount in operation 1050, the water purification apparatus 1 may identify whether the user input to stop discharging the liquid is obtained in operation 1040.

When the discharged amount of the liquid is equal to or larger than the set amount in operation 1050, the water purification apparatus 1 may display an accumulated discharged amount of the liquid and increase the set amount in operation 1060.

The processor 190 may control the display 119 to display the amount of the liquid discharged through the dispenser 50 based on the amount of the liquid discharged through the dispenser 50 equal to or larger than the set amount.

For example, the processor 190 may control the display 119 to display the set amount compared with the discharged amount of the liquid, based on the amount of the liquid discharged through the dispenser 50 equal to or larger than the set amount. In another example, the processor 190 may control the display 119 to display an amount of the liquid identified based on an output signal of the flow sensor 130.

The processor 190 may increase the set amount by a unit increment (e.g., the first set amount, 1 ml or 10 ml) based on the amount of the liquid discharged through the dispenser 50 equal to or larger than the set amount.

For example, when the first set amount is 10 ml and the current set amount is 20 ml, the processor 190 may change the set amount to 30 ml based on the discharged amount of the liquid being 20 ml or more.

As such, the water purification apparatus 1 may display a discharged amount of the liquid each time the amount of the liquid discharged through the dispenser 50 equal to or larger than the set amount. Accordingly, the water purification apparatus 1 may display the amount of the liquid discharged through the dispenser 50 almost real-time.

For example, as shown in FIG. 8, a temperature and a target amount of the liquid selected by the user may be displayed on the display 119 while discharging is waited for. When a user input to discharge the liquid is obtained from the user, an amount of the liquid discharged through the dispenser 50 may be displayed on the display 119 in the unit of the set amount. For example, as the discharged amount increases, 0 ml, 10 ml, 20 ml, . . . , 110 ml and 120 ml may be sequentially displayed on the display 119.

The user may recognize the amount of the liquid discharged through the dispenser 50 based on numbers, text or symbols displayed on the display 119.

The water purification apparatus 1 may identify whether the discharged amount of the liquid is equal to or larger than a target amount set based on a user input, in operation 1070.

The processor 190 may compare the discharged amount of the liquid, which is identified based on the output signal of the flow sensor 130, with the target amount set based on the user input, and identify whether the discharged amount of the liquid is equal to or larger than the target amount.

The processor 190 may identify that the discharged amount of the liquid is less than the target amount, when the liquid is discharged without setting the target amount of the liquid to be discharged.

When the discharged amount of the liquid is less than the target amount in operation 1070, the water purification apparatus 1 may identify whether a user input to stop discharging the liquid is obtained in operation 1040, identify whether the discharged amount of the liquid is equal to or larger than the set amount in operation 1050, and display an accumulated discharged amount of the liquid and increase the set amount in operation 1060.

When a discharged amount of the liquid is equal to or larger than the target amount in operation 1070, the water purification apparatus 1 may stop discharging the liquid, in operation 1080.

In response to the amount of the liquid discharged through the dispenser 50 equal to or larger than the target amount, the processor 190 may control the valve drive 140a to stop discharging the liquid.

As described above, the water purification apparatus 1 may display an discharged amount of the liquid each time the amount of the liquid discharged through the dispenser 50 equal to or larger than the set amount. Accordingly, the water purification apparatus 1 may display the amount of the liquid discharged up to present to the user in almost real-time.

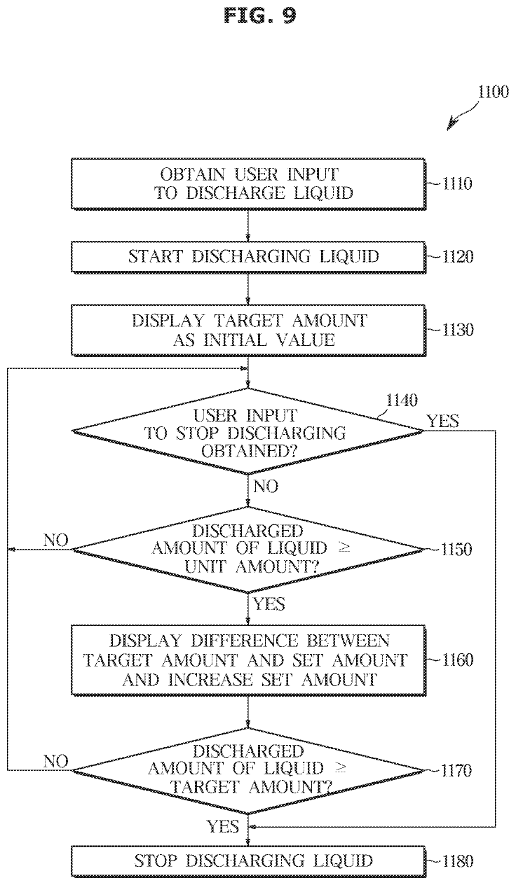

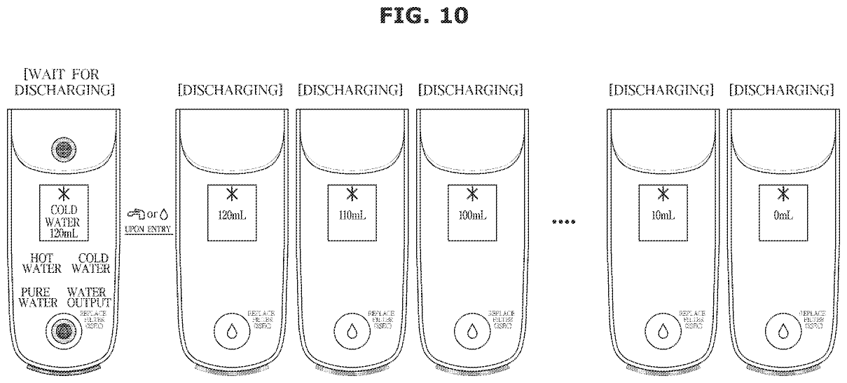

FIG. 9 illustrates an operation of a water purification apparatus discharging a liquid, according to an embodiment. FIG. 10 illustrates an example of displaying a discharged amount of a liquid, according to the operation shown in FIG. 9.

Operations 1100 of the water purification apparatus 1 discharging a liquid will be described in connection with FIG. 9 and FIG. 10.

The water purification apparatus 1 may obtain a user input to discharge the liquid as much as a target discharge amount in operation 1120, and start discharging the liquid in operation 1120.

The operation 1110 and operation 1120 may be the same as the operation 1010 and operation 1020 shown in FIG. 7, respectively.

The water purification apparatus 1 may display a target amount to be an initial value, in operation 1130.

The processor 190 may control the display 119 to display an amount of the liquid discharged through the dispenser 50 while the liquid is being discharged. For example, the processor 190 may display a target amount set based on the user input when discharging of the liquid is started. When the target amount is 120 ml according to the user input, the processor 190 may control the display 119 to display a target discharge amount of “120 ml”.

The water purification apparatus 1 may identify whether a user input to stop discharging the liquid is obtained in 1140 while discharging the liquid, and stop discharging the liquid in operation 1180 when the user input to stop discharging the liquid is identified in operation 1140.

The operation 1140 and the operation 1180 may be the same as the operation 1040 and operation 1080 shown in FIG. 7, respectively.

When the user input to stop discharging the liquid is not identified in 1040, the water purification apparatus 1 may identify whether a discharged amount of the liquid is equal to or larger than a difference between the target amount and the set amount in 1150. When the discharged amount of the liquid is less than the set amount in 1150, the water purification apparatus 1 may identify whether the user input to stop discharging the liquid is obtained in 1140.

The operation 1150 may be the same as the operation 1050 of FIG. 7.

When the discharged amount of the liquid is equal to or larger than the set amount in 1150, the water purification apparatus 1 may display the difference between the target amount and the set amount and then increase the set amount in operation 1060.

The processor 190 may control the display 119 to display the difference between the target amount and the set amount based on the amount of the liquid discharged through the dispenser 50 equal to or larger than the set amount.

For example, when the target amount is 120 ml, the set amount is 10 ml, and the discharged amount of the liquid is 10 ml or more, the processor 190 may control the display 119 to display the difference of 110 ml between the target amount and the set amount.

The processor 190 may increase the set amount by the unit increment (e.g., the first set amount, 1 ml or 10 ml) based on the amount of the liquid discharged through the dispenser 50 equal to or larger than the set amount.

For example, as shown in FIG. 10, a temperature and a target amount of the liquid selected by the user may be displayed on the display 119 while discharging is waited for. When a user input to discharge the liquid is obtained from the user, an amount of the liquid to be further discharged from the target amount may be displayed on the display 119 in the unit of the set amount. For example, as the discharged amount increases, 120 ml, 110 ml, 100 ml, . . . , 10 ml and 0 ml may be sequentially displayed on the display 119.

The user may recognize an extra amount of the liquid to be further discharged based on numbers, text or symbols displayed on the display 119.

The water purification apparatus 1 may identify whether the discharged amount of the liquid is equal to or larger than the target amount set based on a user input, in 1170. When the discharged amount of the liquid is equal to or larger than the target amount in 1170, the water purification apparatus 1 may stop discharging the liquid, in 1180.

The operation 1170 and the operation 1180 may be the same as the operation 1070 and the operation 1080 shown in FIG. 7, respectively.

As described above, the water purification apparatus 1 may subtract the discharged amount of the liquid from the target amount and display the remaining amount to be discharged each time the discharged amount of the liquid through the dispenser 50 equal to or larger than the set amount. Accordingly, the water purification apparatus 1 may provide the remaining amount to be discharged to the user in almost real-time.

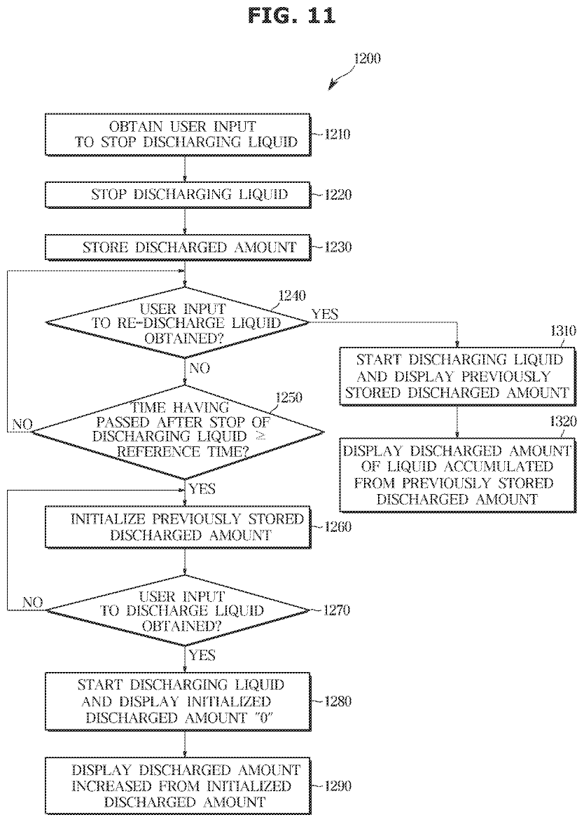

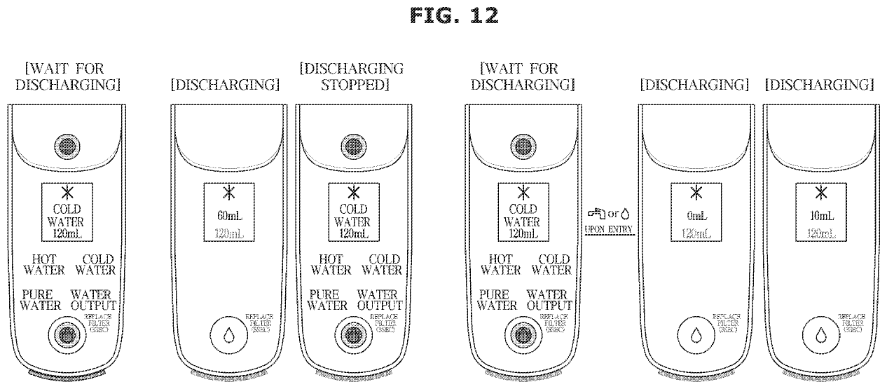

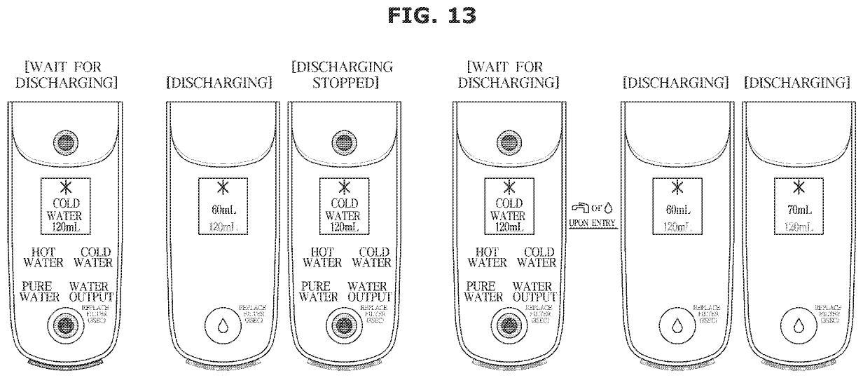

FIG. 11 illustrates an operation of a water purification apparatus re-discharging a liquid, according to an embodiment. FIG. 12 illustrates an example of displaying a discharged amount of a liquid, after initialization of a previously discharged amount, according to the operation shown in FIG. 11. FIG. 13 illustrates an example of displaying a discharged amount of a liquid, by adding a previously discharged amount, according to the operation shown in FIG. 11.

In connection with FIG. 11, FIG. 12 and FIG. 13, operations 1200 in which the water purification apparatus 1 re-discharges the liquid will be described.

The water purification apparatus 1 may obtain a user input to stop discharging the liquid, in operation 1210.

In response to a user input to discharge the liquid, the processor 190 may control the valve drive 140a to discharge the liquid (hot water, cold water or purified water). The processor 190 may control the display 119 to display a discharged amount of the liquid in the unit of a set amount while the liquid is being discharged.

The processor 190 may obtain the user input to stop discharging the liquid while the liquid is being discharged. For example, the processor 190 may identify the user input to stop discharging the liquid when the dispensing button 116 of the user interface 110 is touched or the dispensing lever 120 is pressed.

The water purification device 1 may stop discharging the liquid, in operation 1220.

The processor 190 may control the valve drive 140a to stop discharging the liquid (hot water, cold water or purified water) based on the user input to stop discharging the liquid.

The water purification apparatus 1 may store a discharged amount of the liquid in operation 1230.

The processor 190 may identify the discharged amount of the liquid in response to the user input to stop discharging the liquid, and store the discharged amount of the liquid in the memory 191.

The water purification apparatus 1 may identify whether a user input to re-discharge the liquid is obtained, in operation 1240.

The processor 190 may identify whether a user input to request discharging of the liquid is obtained through the dispensing button 116 of the user interface 110 or the dispensing switch 121 of the dispensing lever 120.

When the user input to re-discharge the liquid is not obtained in operation 1240, the water purification apparatus 1 may identify whether a time that has passed after discharging of the liquid is stopped equal to or longer than a reference time in operation 1250.

The processor 190 may include, for example, a timer, and start counting up or down the timer in response to the stop of discharging the liquid.

The processor 190 may compare the time counted by the timer with the reference time. The reference time may be set to e.g., a time that may be settled by the user having no intention of further discharging the liquid. The reference time may be set experimentally or empirically.

When the time that has passed after the stop of discharging the liquid is shorter than the reference time in operation 1250, the water purification apparatus 1 may identify whether the user input to re-discharge the liquid is obtained in operation 1240, and identify whether the time that has passed after the stop of discharging the liquid is equal to or longer than the reference time in operation 1250.

When the time that has passed after the stop of discharging the liquid is equal to or longer than the reference time in operation 1250, the water purification apparatus 1 may initialize the discharged amount of the liquid, which is stored before.

The processor 190 may initialize the discharged amount of the liquid, which is stored in the memory 191, in operation 1230. For example, the processor 190 may modify the discharged amount of the liquid, which is stored in the memory 191, to “0”.

After this, the water purification apparatus 1 may identify whether a user input to discharge the liquid is obtained, in operation 1270.

The operation 1270 may be the same as the operation 1240.

When the user input to discharge the liquid is not obtained in operation 1270, the water purification apparatus 1 may continue to identify whether the user input to re-discharge the liquid is obtained.

When the user input to discharge the liquid is obtained in operation 1270, the water purification apparatus 1 may start discharging the liquid and display the initial discharged amount of “0” in 1280.

The operation 1280 may be the same as the operation 1020 and the operation 1030 shown in FIG. 7.

The water purification apparatus 1 may display a discharged amount of the liquid by increasing the discharged amount from the initialized discharged amount while discharging the liquid, in operation 1290.

The processor 190 may control the display 119 to display an accumulated discharged amount of the liquid from the initialized discharged amount of “0”.

The processor 190 may compare the discharged amount of the liquid with a set amount, and identify whether the discharged amount of the liquid is equal to or larger than the set amount. The processor 190 may control the display 119 to display the set amount based on the amount of the liquid discharged through the dispenser 50 equal to or larger than the set amount, and increase the set amount by the unit increment.

For example, as shown in FIG. 12, the processor 190 may start discharging the liquid in response to the user input through the dispensing button 116 or the dispensing lever 120 while waiting for discharging, and discharge the liquid up to 60 ml. The processor 190 may stop discharging the liquid in response to a user input through the dispensing button 116 or the dispensing lever 120 during the discharging.

After this, the reference time may elapse while the discharging is waited for, and the processor 190 may start discharging the liquid in response to the user input through the dispensing button 116 or the dispensing lever 120 during the waiting time for the discharging. In this case, the processor 190 may display the amount of discharging by increasing the discharged amount of the liquid on a 10 ml basis from the initial discharged amount “0”, as shown in FIG. 12.

When the user input to re-discharge the liquid is obtained in operation 1240, the water purification apparatus 1 may start discharging the liquid and display the previously stored discharged amount in 1310.

When the user input to re-discharge the liquid is obtained when the time that has passed after the discharging of the liquid was stopped is less than the reference time, the processor 190 may control the valve drive 140a to discharge the liquid and control the display 119 to display the previously discharged amount stored in the memory 191. Furthermore, the processor 190 may set the set amount for discharging the liquid to a sum of the previously discharged amount stored in the memory 191 and a unit increment (e.g., 10 ml). For example, when the amount of the liquid discharged before the stop of discharging the liquid is 60 ml, the processor 190 may control the display to display 60 ml and set the set amount to 70 ml.

The water purification apparatus 1 may display a discharged amount of the liquid by increasing the discharged amount from the previously discharged amount while discharging the liquid, in operation 1320.

The processor 190 may control the display 119 to display an accumulated discharged amount of the liquid from the previously discharged amount stored in the memory 191.

The processor 190 may compare the discharged amount of the liquid (in the aforementioned example, 60 ml) with the set amount (in the aforementioned example, 70 ml), and identify whether the discharged amount of the liquid is equal to or larger than the set amount. The processor 190 may control the display 119 to display the set amount based on the amount of the liquid discharged through the dispenser 50 equal to or larger than the set amount, and increase the set amount by the unit increment.

For example, as shown in FIG. 13, the processor 190 may start discharging the liquid in response to the user input through the dispensing button 116 or the dispensing lever 120 while waiting for discharging, and discharge the liquid up to 60 ml. The processor 190 may stop discharging the liquid in response to the user input through the dispensing button 116 or the dispensing lever 120 during the discharging.

After this, before the passage of the reference time while the discharging is waited for, the processor 190 may start discharging the liquid in response to the user input through the dispensing button 116 or the dispensing lever 120. In this case, the processor 190 may display a discharged amount by increasing the discharged amount of the liquid on a basis of a unit increment of 10 ml from the previously discharged amount of 60 ml. The processor 190 may control the display 119 to display the discharged amount of the liquid in a sequence of 60 ml, 70 ml, 80 ml, and so on.

As described above, when the user input for re-discharging is obtained within the reference time after the stop of discharging the liquid, the water purification apparatus 1 may add the re-discharged amount to the discharged amount before the stop of discharging the liquid and display the accumulated discharged amount of the liquid.

The user may pause discharging the liquid and resume the discharging that has been paused. In this case, the water purification apparatus 1 may provide a total amount of the liquid discharged before or after the pause of discharging the liquid to the user.

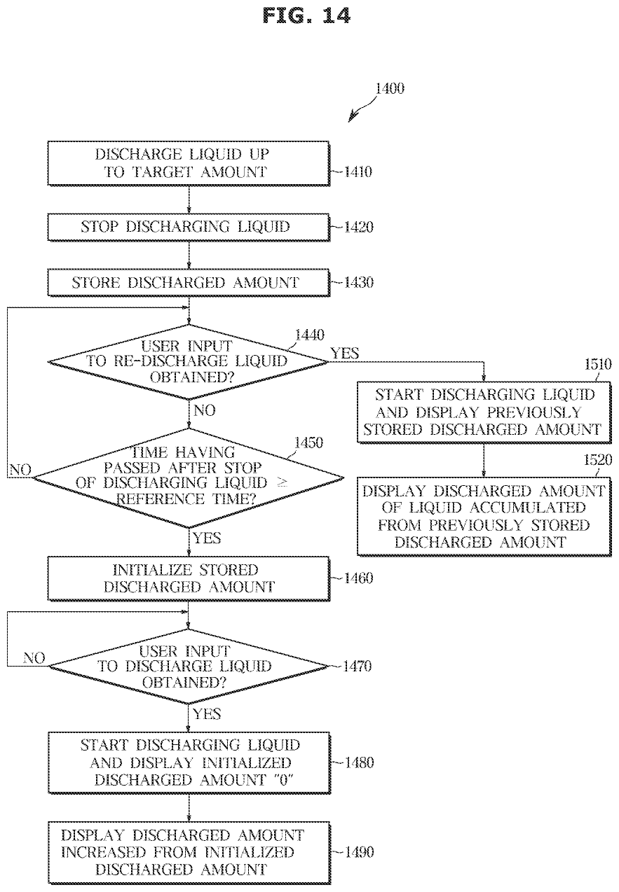

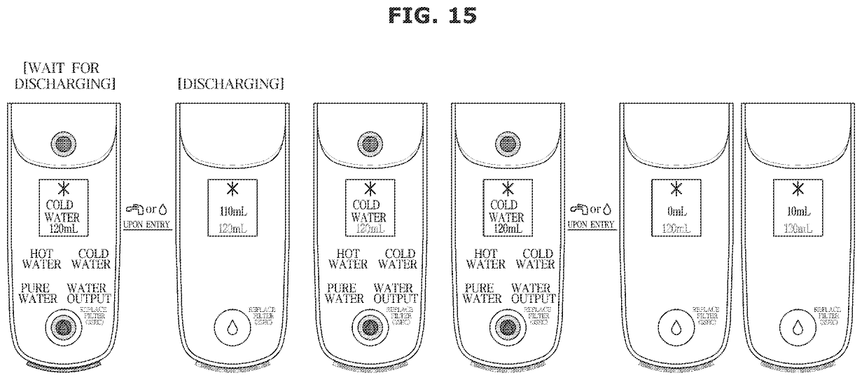

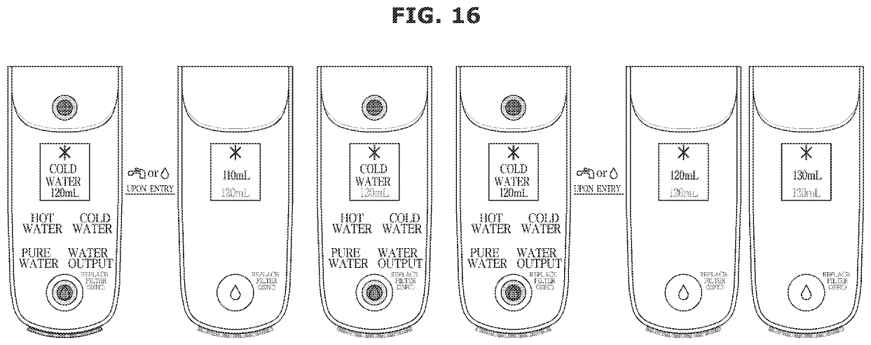

FIG. 14 illustrates an operation of a water purification apparatus re-discharging a liquid, according to an embodiment. FIG. 15 illustrates an example of displaying a discharged amount of a liquid, after initialization of a previously discharged amount, according to the operation shown in FIG. 14. FIG. 16 illustrates an example of displaying a discharged amount of a liquid, by adding a previously discharged amount, according to the operation shown in FIG. 14.

In connection with FIG. 14, FIG. 15 and FIG. 16, operations 1400 in which the water purification apparatus 1 re-discharges the liquid will be described.

The water purification apparatus 1 may discharge a liquid up to a target amount, in operation 1410.

In response to a user input to discharge the liquid, the processor 190 may control the valve drive 140a to discharge the liquid (hot water, cold water or purified water) to the target amount. The processor 190 may control the display 119 to display a discharged amount of the liquid in the unit of a set amount while the liquid is being discharged.

The water purification device 1 may stop discharging the liquid, in operation 1420.

The processor 190 may control the valve drive 140a to stop discharging the liquid (hot water, cold water or purified water) based on the discharged amount of the liquid equal to or larger than the target amount.

The water purification apparatus 1 may store the discharged amount of the liquid, in operation 1430.

The processor 190 may identify the discharged amount of the liquid in response to the discharged amount of the liquid equal to or larger than the target amount, and store the discharged amount of the liquid in the memory 191.

The water purification apparatus 1 may identify whether a user input to re-discharge the liquid is obtained, in operation 1440.

The operation 1440 may be the same as the operation 1240 of FIG. 11.

When the user input to re-discharge the liquid is not obtained in operation 1440, the water purification apparatus 1 may identify whether a time that has passed after discharging of the liquid is stopped equal to or longer than a reference time in operation 1450.

The operation 1450 may be the same as the operation 1250 of FIG. 11.

When the time that has passed after the stop of discharging the liquid is shorter than the reference time in operation 1450, the water purification apparatus 1 may identify whether the user input to re-discharge the liquid is obtained in operation 1440, and identify whether the time that has passed after the stop of discharging the liquid is equal to or longer than the reference time in operation 1450.

When the time that has passed after the stop of discharging the liquid is equal to or longer than the reference time in operation 1450, the water purification apparatus 1 may initialize the discharged amount of the liquid, which is stored before, in operation 1460.

The operation 1460 may be the same as the operation 1260 of FIG. 11.

After this, the water purification apparatus 1 may identify whether a user input to discharge the liquid is obtained, in 1470.

The operation 1470 may be the same as the operation 1440.

When the user input to discharge the liquid is not obtained in operation 1470, the water purification apparatus 1 may continue to identify whether the user input to re-discharge the liquid is obtained.

When the user input to discharge the liquid is obtained in operation 1470, the water purification apparatus 1 may start discharging the liquid and display the initialized discharged amount of “0” in operation 1480.

The operation 1480 may be the same as the operation 1280 of FIG. 11.

The water purification apparatus 1 may display a discharged amount of the liquid by increasing the discharged amount from the initialized discharged amount while discharging the liquid, in 1490.

The operation 1490 may be the same as the operation 1290 of FIG. 11.

For example, as shown in FIG. 15, the processor 190 may start discharging the liquid in response to the user input through the dispensing button 116 or the dispensing lever 120 while waiting for discharging, and discharge the liquid up to the target amount of 120 ml selected by the user. When the discharged amount reaches the target amount, the processor 190 may stop discharging the liquid.

After this, the reference time may elapse while the discharging is waited for, and the processor 190 may start discharging the liquid in response to the user input through the dispensing button 116 or the dispensing lever 120 during the waiting time for the discharging. In this case, the processor 190 may display the amount of discharging by increasing the discharged amount of the liquid on a 10 ml basis from the initialized discharged amount of “0”, as shown in FIG. 15.

When the user input to re-discharge the liquid is obtained in 1440, the water purification apparatus 1 may start discharging the liquid and display the previously stored discharged amount in 1510.

The operation 1510 may be the same as the operation 1310 of FIG. 11.

The water purification apparatus 1 may display a discharged amount of the liquid by increasing the discharged amount from the previously discharged amount while discharging the liquid, in 1520.

The operation 1520 may be the same as the operation 1320 of FIG. 11.

For example, as shown in FIG. 16, the processor 190 may start discharging the liquid in response to the user input through the dispensing button 116 or the dispensing lever 120 while waiting for discharging, and discharge the liquid up to the target amount of 120 ml selected by the user. When the discharged amount reaches the target amount, the processor 190 may stop discharging the liquid.

After this, before the passage of the reference time while the discharging is waited for, the processor 190 may start discharging the liquid in response to the user input through the dispensing button 116 or the dispensing lever 120. In this case, the processor 190 may display the discharged amount by increasing the discharged amount of the liquid on a basis of 10 ml of unit increment from the previously discharged amount of 120 ml, as shown in FIG. 16. The processor 190 may control the display 119 to display the discharged amount of the liquid e.g., in a sequence of 120 ml, 130 ml, 140 ml, and so on.

As described above, when the user input for re-discharging is obtained within the reference time after the target amount is discharged, the water purification apparatus 1 may add the re-discharged amount to the target amount already discharged and display the accumulated discharged amount of the liquid.

After the target amount is discharged, the user may instruct additional discharging of the liquid. In this case, the water purification apparatus 1 may provide a total amount of the target discharge amount and the additionally discharged amount of the liquid.

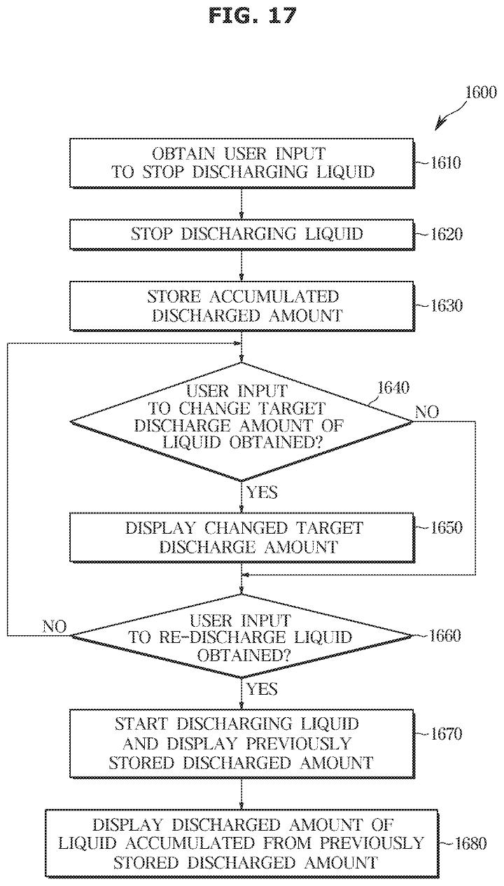

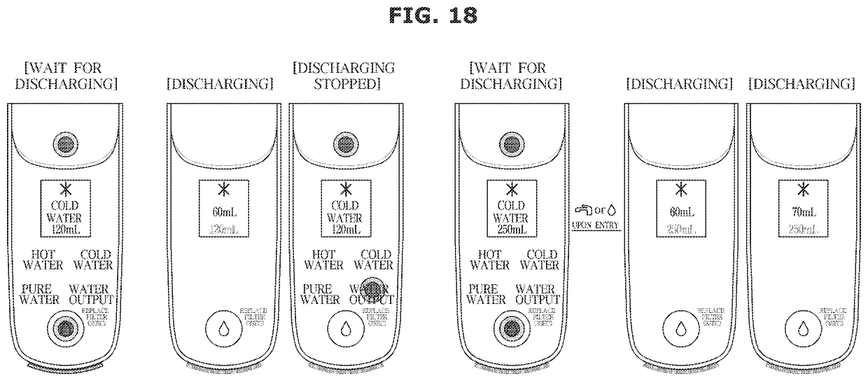

FIG. 17 illustrates an operation of a water purification apparatus re-discharging a liquid, according to an embodiment. FIG. 18 illustrates an example of displaying a discharged amount of a liquid, by adding a previously discharged amount, according to the operation shown in FIG. 17.

Operations 1600 of the water purification apparatus 1 re-discharging a liquid will be described in connection with FIG. 17 and FIG. 18.

The water purification apparatus 1 may obtain a user input to stop discharging the liquid in operation 1610, and stop discharging the liquid in operation 1620. Furthermore, the water purification apparatus 1 may store a discharged amount of the liquid in operation 1630.

Operation 1610, operation 1620 and operation 1630 may be the same as the operation 1210, operation 1220 and operation 1230 shown in FIG. 11, respectively.

The water purification apparatus 1 may identify whether a user input to change the target discharge amount of the liquid is obtained, in operation 1640.

The user may stop the water purification apparatus 1 from discharging the liquid, and change the target discharge amount of the water purification apparatus 1.

For example, the user may change the target amount of the liquid through the setting button 115 while the discharging of the liquid is stopped. As shown in FIG. 18, the user may enter the user input to change the target amount from 120 ml to 250 ml by touching the setting button 115 one time.

When it is identified that the user input to change the target discharge amount of the liquid is obtained in operation 1640, the water purification apparatus 1 may display the changed target discharge amount in operation 1650.

The processor 190 may change the target discharge amount based on the user input to change the target discharge amount of the liquid obtained. Furthermore, the processor 190 may control the display 119 to display the changed target discharge amount. For example, as shown in FIG. 18, the processor 190 may control the display 119 to display the changed target amount of 250 ml.

After this, the water purification apparatus 1 may identify whether a user input to re-discharge the liquid is obtained, in operation 1660. When it is not identified that the user input to change the target discharge amount of the liquid is obtained in operation 1640, the water purification apparatus 1 may identify whether the user input to re-discharge the liquid is obtained in operation 1660.

The operation 1660 may be the same as the operation 1240 of FIG. 11.

When the user input to re-discharge the liquid is not obtained in operation 1660, the water purification apparatus 1 may identify whether the user input to change the target discharge amount of the liquid is obtained in operation 1640.

When the user input to re-discharge the liquid is not obtained, the processor 190 may identify whether the time that has passed after the stop of discharging the liquid is equal to or longer than the reference time, and initialize the discharged amount of the liquid, which is previously stored, when the time that has passed after the stop of discharging the liquid is equal to or longer than the reference time.

When the user input to re-discharge the liquid is obtained in operation 1660, the water purification apparatus 1 may start discharging the liquid and display the previously stored discharged amount in operation 1670. Furthermore, the water purification apparatus 1 may display a discharged amount of the liquid by increasing the discharged amount from the previously discharged amount while discharging the liquid, in operation 1680.

The operation 1670 and operation 1680 may be the same as the operation 1310 and operation 1320 shown in FIG. 11, respectively.

As described above, the water purification apparatus 1 may change the target discharge amount after stopping discharging of the liquid in response to the user input, add the re-discharged amount to the amount previously discharged before stopping discharging of the liquid after the change of the target amount, and display the accumulated discharged amount of the liquid.

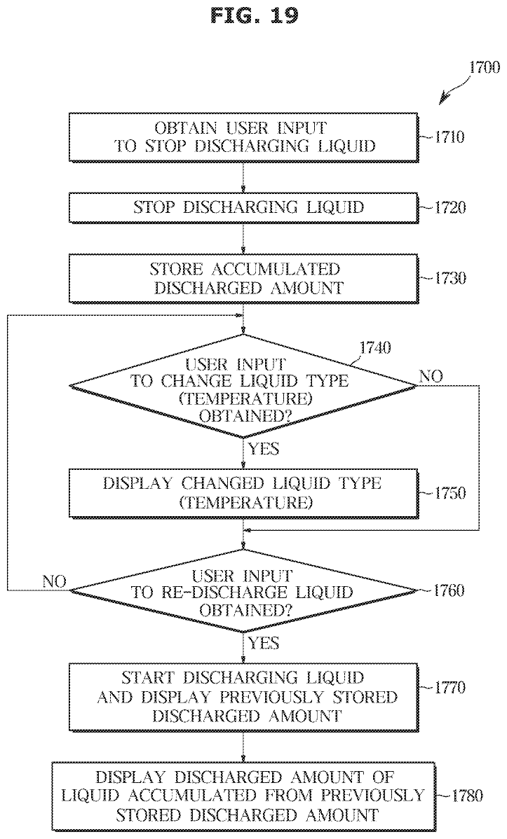

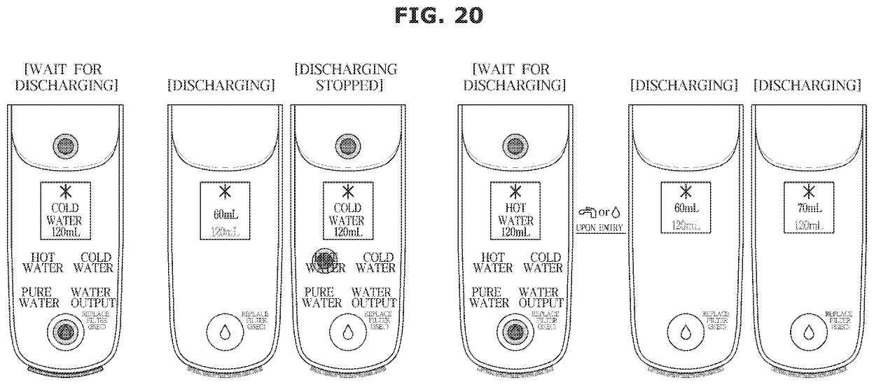

FIG. 19 illustrates an operation of a water purification apparatus re-discharging a liquid, according to an embodiment. FIG. 20 illustrates an example of displaying a discharged amount of a liquid, by adding a previously discharged amount, according to the operation shown in FIG. 19.

Operations 1700 of the water purification apparatus 1 re-discharging a liquid will be described in connection with FIG. 19 and FIG. 20.

The water purification apparatus 1 may obtain a user input to stop discharging the liquid in operation 1710, and stop discharging the liquid in operation 1720. Furthermore, the water purification apparatus 1 may store a discharged amount of the liquid in operation 1730.

Operation 1710, operation 1720 and 1730 may be the same as the operation 1210, operation 1220 and operation 1230 shown in FIG. 11, respectively.

The water purification apparatus 1 may identify whether a user input to change a liquid type (temperature or hot water/cold water) to be discharged is obtained, in operation 1740.

The user may stop the water purification apparatus 1 from discharging the liquid, and change the type of the liquid to be discharged by the water purification apparatus 1.

For example, the user may change the type of the liquid through the hot water button 112 or the cold water button 113 while the discharging of the liquid is stopped. As shown in FIG. 20, the user may enter the user input to change the type of the liquid from cold water to hot water by touching the temperature button 112 one time.

When it is identified that the user input to change the type of the liquid (temperature or hot water/cold water) is obtained in operation 1740, the water purification apparatus 1 may display the changed type of the liquid in operation 1750.

The processor 190 may change the type of the liquid based on the user input to change the type of the liquid obtained. Furthermore, the processor 190 may control the display 119 to display the changed type of the liquid. For example, as shown in FIG. 20, the processor 190 may control the display 119 to display the changed type of the liquid, e.g., “hot water”.

After this, the water purification apparatus 1 may identify whether a user input to re-discharge the liquid is obtained, in operation 1760. When it is not identified that the user input to change the target discharge amount of the liquid is obtained in 1740, the water purification apparatus 1 may identify whether the user input to re-discharge the liquid is obtained in operation 1760.

The operation 1760 may be the same as the operation 1240 of FIG. 11.

When the user input to re-discharge the liquid is not obtained in operation 1760, the water purification apparatus 1 may identify whether the user input to change the target discharge amount of the liquid is obtained in operation 1740.

When the user input to re-discharge the liquid is not obtained, the processor 190 may identify whether the time that has passed after the stop of discharging the liquid is equal to or longer than the reference time, and initialize the discharged amount of the liquid, which is previously stored, when the time that has passed after the stop of discharging the liquid is equal to or longer than the reference time.

When the user input to re-discharge the liquid is obtained in operation 1760, the water purification apparatus 1 may start discharging the liquid and display the previously stored discharged amount in operation 1770. Furthermore, the water purification apparatus 1 may display the discharged amount of the liquid by increasing the discharged amount from the previous discharged amount while discharging the liquid, in operation 1780.

The operation 1770 and operation 1780 may be the same as the operation 1310 and operation 1320 shown in FIG. 11, respectively.

As described above, the water purification apparatus 1 may change the type of the liquid (temperature or hot water/cold water) discharged after discharging of the liquid is stopped in response to the user input, add the re-discharged amount to the previously discharged amount before discharging of the liquid is stopped after the type of the liquid is changed, and display the accumulated discharged amount of the liquid.

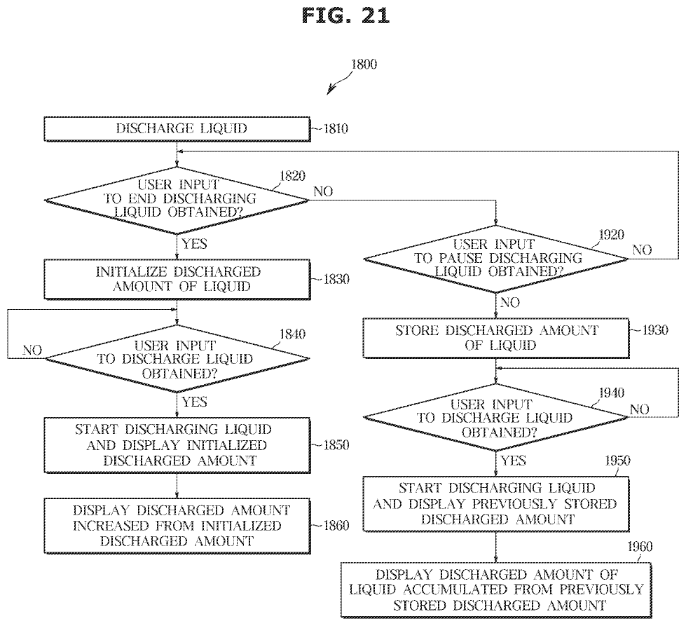

FIG. 21 illustrates an operation of a water purification apparatus pausing discharging of a liquid, according to an embodiment.

In connection with FIG. 21, operations 1600 of the water purification apparatus 1 pausing the discharging of the liquid will be described.

The water purification apparatus 1 may discharge the liquid in operation 1810.

In response to a user input to discharge the liquid, the processor 190 may control the valve drive 140a to discharge the liquid (hot water, cold water or purified water). The processor 190 may control the display 119 to display a discharged amount of the liquid in the unit of a set amount while the liquid is being discharged.

The water purification apparatus 1 identifies whether a user input to stop discharging the liquid is obtained in operation 1820.

The processor 190 may obtain the user input to stop discharging the liquid from the user interface 110 or the dispensing lever 120.

For example, the processor 190 may identify the user input to stop discharging the liquid based on an output signal of the dispensing switch 121 that represents a fact that the dispensing lever 120 is pressed while the liquid is being discharged.

Furthermore, the processor 190 may identify the user input to stop discharging the liquid based on an output signal of the user interface 110 that represents double-tap or long-press on the dispensing button 116 while the liquid is being discharged. The double-tap may refer to touching on the dispensing button 116 two times with a short time interval. The long-press may refer to touching on the dispensing button 116 that lasts for a preset time (e.g., 2 to 3 seconds).

When the user input to stop discharging the liquid is obtained in operation 1820, the water purification apparatus 1 may initialize the discharged amount of the liquid, in operation 1830.

The processor 190 may initialize the discharged amount of the liquid, which is stored in the memory 191. For example, the processor 190 may modify the discharged amount of the liquid, which is stored in the memory 191, to “0”.

After this, the water purification apparatus 1 may identify whether a user input to discharge the liquid is obtained, in operation 1840.

The operation 1840 may be the same as the operation 1240 of FIG. 11.

When the user input is not obtained in operation 1840, the water purification apparatus 1 may wait for the user input.

When the user input to discharge the liquid is obtained in operation 1840, the water purification apparatus 1 may start discharging the liquid and display the initialized discharged amount of “0” in operation 1850.

The operation 1850 may be the same as the operation 1020 and operation 1030 shown in FIG. 7.

The water purification apparatus 1 may display a discharged amount of the liquid by increasing the discharged amount from the initialized discharged amount while discharging the liquid, in operation 1860.

The operation 1860 may be the same as the operation 1290 of FIG. 11.

As such, the water purification apparatus 1 may initialize the previously discharged amount, based on the user input to stop discharging the liquid. The water purification apparatus 1 may display a discharge amount discharged after initialization of the discharged amount on the display 119.

When the user input to stop discharging the liquid is not obtained in 1820, the water purification apparatus 1 identifies whether a user input to pause discharging the liquid is obtained in operation 1920.

The processor 190 may obtain a user input to stop discharging the liquid from the user interface 110 or the dispensing lever 120.

For example, the processor 190 may identify the user input to stop discharging the liquid based on an output signal of the user interface 110 that represents a tap on the dispensing button 116 while the liquid is being discharged. The tap may refer to touching on the dispensing button 116 for a certain period of time. The touch for the tap may not be repeated as compared to the double-tap, and may not be continued for a long time as compared to the long-press.

When the user input to pause discharging the liquid is obtained in operation 1920, the water purification apparatus 1 may store the discharged amount of the liquid, in operation 1930.

The processor 190 may store the discharged amount of the liquid in the memory 191.

After this, the water purification apparatus 1 may identify whether a user input to discharge the liquid is obtained, in operation 1940.

The operation 1940 may be the same as the operation 1240 of FIG. 11.

When the user input is not obtained in operation 1940, the water purification apparatus 1 may wait for the user input.

When the user input is obtained in operation 1940, the water purification apparatus 1 may start discharging the liquid and display the previously stored discharged amount in operation 1950.

The operation 1950 may be the same as the operation 1310 of FIG. 11.

The water purification apparatus 1 may display a discharged amount of the liquid by increasing the discharged amount from the previously discharged amount while discharging the liquid, in operation 1960.

The operation 1960 may be the same as the operation 1320 of FIG. 11.

As such, the water purification apparatus 1 may store the previously discharged amount, based on the user input to pause discharging the liquid. Furthermore, the water purification apparatus 1 may add the additionally discharge amount to the stored discharged amount, and display the accumulated discharged amount on the display 119.

Accordingly, the water purification apparatus 1 may offer an option for the user to stop or pause discharging the liquid.

According to an embodiment, a water purification apparatus includes a flow path; a dispenser arranged at one end of the flow path; a user interface arranged on the dispenser; a valve arranged in the flow path; a valve drive operatively connected to the valve; a flow sensor arranged in the flow path; and a processor operatively connected to the user interface, the valve drive and the flow sensor. The processor may include instructions to control the valve drive to open the valve to start discharging a liquid based on a user input obtained through the user interface, identify a discharged amount of the liquid after the start of discharging the liquid, based on an output signal of the flow sensor, and control the user interface to display a total discharged amount of the liquid discharged before stopping the discharging of the liquid after the start of the discharging of the liquid, based on resumption of discharging of the liquid after stopping discharging of the liquid.

As such, the user may pause discharging the liquid and resume the discharging that has been paused. In this case, the water purification apparatus may provide a total amount of the liquid discharged before or after the pause of discharging the liquid to the user. Accordingly, the water purification apparatus may provide a total discharged amount of the liquid even when discharging the liquid intermittently. Furthermore, the user may determine whether a required amount of the liquid has been discharged even when the liquid is intermittently discharged.

The processor may include an instruction for closing the valve based on reception of a user input to stop discharging the liquid and storing the total discharged amount of the liquid discharged before stopping the discharging of the liquid after the start of the discharging of the liquid.

The processor may include an instruction for opening the valve and displaying the stored total discharged amount of the liquid, based on reception of a user input to resume discharging the liquid within a reference time after the stop of discharging the liquid.

The processor may include an instruction for initializing the stored discharged amount of the liquid, based on passage of the reference time after stopping discharging of the liquid.

The processor may include an instruction for opening the valve and displaying the initialized discharged amount of the liquid, based on reception of a user input to resume discharging the liquid after the reference time elapses.

Accordingly, the water purification apparatus may provide a total discharged amount of the liquid to the user by storing the discharged amount of the liquid in the memory or initializing the discharged amount of the liquid without an extra configuration.

The processor may include an instruction for closing the valve based on a discharged amount of the liquid based on an output signal of the flow sensor equal to or larger than a target amount.

The processor may include an instruction for closing the valve based on reception of a user input to stop discharging the liquid through the user interface.

The processor may include an instruction for stopping discharging of the liquid and storing a total discharged amount of the liquid discharged before the stop of discharging the liquid after the start of discharging the liquid, and resuming discharging of the liquid and displaying the stored discharged amount of the liquid based on reception of a user input to resume discharging the liquid.

The processor may include an instruction for stopping discharging of the liquid based on reception of a user input to stop discharging the liquid, and resuming discharging of the liquid and displaying an initial discharged amount of the liquid based on reception of a user input to resume discharging the liquid.

The user interface may include a button to obtain a user input to pause discharging the liquid, and the water purification apparatus may include a lever for obtaining a user input to stop discharging the liquid.

The user interface may include a touch button, and the processor may include an instruction for obtaining a user input to pause discharging the liquid based on reception of a touch input shorter than a reference time through the touch button, and obtaining a user input to stop discharging the liquid based on reception of a touch input longer than the reference time through the touch button.

Accordingly, the water purification apparatus may offer a pause option for displaying an accumulated discharged amount and an option of stopping discharging for displaying an initialized discharged amount.

The processor may include an instruction for displaying a discharged amount which increases by a unit amount from an initial discharged amount each time the discharged amount of the liquid based on an output signal of the flow sensor reaches the unit amount.

The processor may include an instruction for displaying a discharged amount which decreases by a unit amount from a target amount each time a discharged amount of the liquid based on an output signal of the flow sensor reaches the unit amount.

Accordingly, the water purification apparatus may provide the user with an exact discharged amount of the liquid.

The embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The machine-readable storage medium may be provided in the form of a non-transitory storage medium. The term ‘non-transitory’ storage medium may mean that the storage medium is a tangible device which does not include a signal, e.g., electromagnetic waves, without distinguishing between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Embodiments of the disclosure have been described with reference to accompanying drawings. It will be understood by people of ordinary skill in the art that the present disclosure may be practiced in other forms than the embodiments as described above without changing the technical idea or essential features of the present disclosure. The above embodiments are only by way of example, and should not be interpreted in a limited sense.

What is claimed is:

1. A water purification apparatus comprising:
a flow path;
a dispenser provided at one end of the flow path;
a user interface provided on the dispenser;
a valve provided in the flow path;
a valve drive operatively connected to the valve;
a flow sensor provided in the flow path;
a memory storing instructions; and
a processor operatively connected to the user interface, the valve drive, the flow sensor, and the memory,
wherein the processor is configured to execute the instructions to:
control, based on an input obtained through the user interface, a start of discharging a liquid by controlling the valve drive to open the valve and discharge the liquid,
identify, based on an output signal of the flow sensor, a discharged amount of the liquid after the start of discharging the liquid, and
control, based on a resumption of discharging of the liquid after a stop of discharging the liquid, the user interface to display a total discharged amount of the liquid discharged before the stop of discharging of the liquid and after the start of discharging of the liquid.

2. The water purification apparatus of claim 1, wherein the processor is further configured to execute the instructions to, based on reception of a user input to stop discharging the liquid, control the valve drive to close the valve and store a total discharged amount of the liquid discharged before the stop of discharging of the liquid and after the start of discharging the liquid.

3. The water purification apparatus of claim 2, wherein the processor is further configured to execute the instructions to, based on reception of a user input to resume discharging the liquid within a reference time after the stop of discharging of the liquid, control the valve drive to open the valve and control the user interface to display the stored total discharged amount of the liquid.

4. The water purification apparatus of claim 3, wherein the processor is further configured to execute the instructions to, based on passage of the reference time after the stop of discharging of the liquid, initialize the stored discharged amount of the liquid.

5. The water purification apparatus of claim 4, wherein the processor is further configured to execute the instructions to, based on reception of a user input to resume discharging the liquid after the reference time elapses, control the valve drive to open the valve and control the user interface to display the initialized discharged amount of the liquid.

6. The water purification apparatus of claim 1, wherein the processor is further configured to execute the instructions to control the valve drive to close the valve based on determining an output signal of the flow sensor to indicate the discharged amount of the liquid to be equal to or larger than a target amount.

7. The water purification apparatus of claim 1, wherein the processor is further configured to execute the instructions to implement control the valve drive to close the valve based on reception of a user input to stop discharging the liquid through the user interface.

8. The water purification apparatus of claim 1, wherein the processor is further configured to execute the instructions to:
stop discharging of the liquid;
store the total discharged amount of the liquid discharged before the stop of discharging the liquid and after the start of discharging the liquid, and
based on reception of a user input to resume discharging of the liquid:
resume discharging of the liquid, and
control the user interface to display the stored discharged amount of the liquid.

9. The water purification apparatus of claim 8, wherein the processor is further configured to execute the instructions to:
end, based on reception of a user input to stop discharging the liquid, discharging of the liquid, and
based on reception of a user input to resume discharging of the liquid:
resume discharging of the liquid, and
control the user interface to display an initial discharged amount of the liquid.

10. The water purification apparatus of claim 9, wherein the user interface comprises a button for receiving a user input to pause discharging of the liquid, and
wherein the water purification apparatus comprises a lever configured to end discharging the liquid.

11. The water purification apparatus of claim 9, wherein the user interface comprises a touch button, and
wherein the processor is further configured to execute the instructions to:
obtain a user input to pause discharging of the liquid based on reception of a touch input, to the touch button, that is shorter than a reference time, and
obtain a user input to end discharging the liquid based on reception of a touch input, to the touch button, that is longer than the reference time.

12. The water purification apparatus of claim 1, wherein the processor is further configured to execute the instructions to control the user interface to display a discharged amount which increases by a unit amount from an initial discharged amount each time the discharged amount of the liquid based on an output signal of the flow sensor reaches the unit amount.

13. The water purification apparatus of claim 1, wherein the processor is further configured to execute the instructions to control the user interface to display a discharged amount which decreases by a unit amount from a target amount each time the discharged amount of the liquid based on an output signal of the flow sensor reaches the unit amount.

14. A method of controlling a water purification apparatus comprising a flow path, a dispenser provided at one end of the flow path and a valve provided in the flow path, the method comprising:
based on a user input obtained through a user interface provided on the dispenser, opening the valve to start discharging a liquid;
displaying a discharged amount of the liquid each time the discharged amount of the liquid is determined, based on an output signal of a flow sensor arranged in the flow path, to reach a unit amount; and
based on resumption of discharging of the liquid after a stop of discharging of the liquid, displaying a total discharged amount of the liquid discharged before the stop of discharging of the liquid and after the start of discharging of the liquid.

15. The method of claim 14, wherein the displaying of the total discharged amount of the liquid discharged before the stop of discharging of the liquid and after the start of discharging of the liquid comprises:
based on reception of a user input to stop discharging the liquid, closing the valve and storing the total discharged amount of the liquid discharged before the stop of discharging of the liquid and after the start of discharging of the liquid, and
based on reception of a user input to resume discharging of the liquid within a reference time after the stop of discharging of the liquid, opening the valve and displaying the stored total discharged amount of the liquid.
